(19) United States
(12) Patent Application Publication
(10) Pub. No.: US 2009/0208137 A1
(43) Pub. Date: Aug. 20, 2009

(54) IMAGE PROCESSING APPARATUS AND IMAGE PROCESSING METHOD

(76) Inventors: Minoru Urushihara, Tokyo (JP); Hiroshi Takeuchi, Kanagawa (JP); Masato Usuki, Kanagawa (JP); Kenkichi Kobayashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/372,675

(22) Filed: Feb. 17, 2009

(30) Foreign Application Priority Data
Feb. 18, 2008 (JP) P2008-036179

(51) Int. Cl. G06K 9/32

(52) U.S. Cl. 382/300; 348/699; 348/E05.066

(57) ABSTRACT

The present invention provides an image processing apparatus that generates interpolation image signals based on a motion vector between continuously input time-series image signals and increases time resolution. The image processing apparatus includes a feature variation detecting unit that detects a predetermined feature variation between the time-series image signals; a generation time setting unit that sets a generation time of the interpolation image signals; and an interpolation image signal generating unit that generates the interpolation image signals at the generation time set by the generation time setting unit. In addition, when the generation time setting unit sets the generation time after the feature variation of the time-series image signals has been detected by the feature variation detecting unit, the generation time setting unit sets the generation time to approximate an approximation time of any one of the time-series image signals whose times are arranged before and after the generation time.

### CROSS REFERENCES TO RELATED APPLICATIONS

The present invention contains subjected matter related to Japanese Patent Application JP 2008-036179 filed in the Japan Patent Office on Feb. 18, 2008, the entire contents of which being incorporated herein by reference.

### BACKGROUND OF THE INVENTION

1. Field of the Invention

The present invention relates to an image processing apparatus and an image processing method.

2. Description of the Related Art

In recent years, with the rapid development of an image processing technology and an information communication technology, a high-definition image digital broadcasting service has been developed. Since the amount of digital broadcasting data of the high-definition image increases, various schemes for economically distributing the digital broadcasting data have been studied. Among them, as encoding technologies for compressing a data capacity while maintaining high-definition image data, for example, compression encoding technologies that are standardized by an MPEG (Moving Picture Experts Group) or a VCEG (Video Coding Experts Group) have been well-known.

Among the compression encoding technologies, an image processing technology called “motion compensation” has been used. A motion compensation process includes a process of extracting the same or most approximated pixel or pixel group (hereinafter, referred to as block) between a plurality of time-series image signals, a process of detecting a motion vector that indicates a direction where the block moves and the movement amount of the block (hereinafter, referred to as motion detection), and a process of compensating for a pixel value of a block location based on the motion vector when differential encoding is performed between the time-series image signals. If this technology is applied, for example, in an image where a moving object included in time-series image signals moves over time, in a scene in which a block that has the same or approximated pixel value is rarely changed and only moves, a data capacity can be greatly reduced without deteriorating an image quality.

As an application example of the above technology, for example, Japanese Patent Application Laid-Open No. 2001-42831 discloses a technology for using a motion vector included in input time-series image signals and generating interpolation image signals between the continuous time-series image signals to increase time resolution. Further, in the same document, an example where the corresponding technology is used in order to improve a display quality of a liquid crystal display device is described. For example, a specific technology is described for applying the corresponding image to a broadcasting image, such as a television image, and improving an image quality of the broadcasting image displayed on the liquid crystal display device (improving a response speed).

### SUMMARY OF THE INVENTION

Further, in an image display device, such as a television receiver or a recording reproducing apparatus, a stream of time-series image signals where a plurality of types of images are mixed may be input. In this case, examples of the types of the images may include an image that is photographed by a television camera (hereinafter, “camera image”), an image of a recording film (hereinafter, referred to as “film image”), and an image by computer graphics (hereinafter, referred to as “CG image”). Of course, different types of images may be mixed and input.

Each of the images has different time resolution. For example, time resolution of the camera image is 60 (or 50) fields/sec. Meanwhile, time resolution of the film image is 24 frames/sec, and the film image is input after the time resolution is converted into 60 fields/sec by a pull-down process. In addition, the CG image is 30 (or 25) frames/sec. However, these numerical values are not limitative but exemplary.

For example, a broadcasting device may receive a stream of time-series signals where the camera image or the film image is mixed. In this case, an interpolation process method needs to be switched between the camera image and the film image. Of course, when different types of images are mixed and input, an interpolation process method needs to be switched in accordance with the types of the images.

For example, in the case of the film image, in a pull-down processed stream, even though interpolation image signals are inserted between continuous time-series image signals, a portion is generated in which substantial time resolution is not improved. For example, in a portion where the same time-series image signal is continuously input, since an interpolation image signal becomes the same as the time-series image signal (original image), it maybe difficult to obtain an interpolation effect even though the interpolation image signal is inserted.

For this reason, the film image needs to be subjected to an interpolation process in a state where pull down is released (24 frames/sec). However, since the film image where pull down is released is different from the camera image in time resolution, the number of inserted interpolation image signals or an insertion time of each of the interpolation image signals may be different.

In general, interpolation image signals are equally generated between continuous time-series image signals. For this reason, when an interpolation process is executed for converting time resolution of the time-series image signals into the same time resolution, the number of interpolation image signals with respect to the film image becomes larger than the number of interpolation image signals with the camera image. As a result, when an interpolation method is switched from the camera image to the film image, if an interpolation process is executed on the film image using an interpolation method for the camera image, the number of interpolation image signals that are generated in the film image becomes smaller than the original number, which results in reducing smoothness of an image.

Accordingly, when an interpolation process is executed on time-series image signals where a camera image and a film image are mixed, an interpolation process method needs to be switched in accordance with the type of the image. However, in order to determine the types of the images, such as the camera image, the film image, and the CG image, a predetermined process time is needed. For this reason, during a switching process including the determination process, an interpolation process itself is stopped or an interpolation process is continuously executed by a different interpolation method. When the switching process is executed, an image quality may be deteriorated (hereinafter, referred to as judders). If the rapid change is generated from an image where the judders are generated to a smooth image, this may give a sense of discomfort to a viewer.

In addition, the judders may be easily generated even in the case where an interpolation process is executed on an image where a motion amount of a moving object is large between continuous time-series image signals. For example, when a motion of the moving object is large and severe, motion prediction precision may be deteriorated, and an interpolation image signal where a linkage with anteroposterior time-series image signals is unnatural may be generated. In this case, the interpolation process may cause unnecessary deterioration of an image quality. In order to prevent the image quality from being deteriorated, a countermeasure is devised in which the interpolation process is not executed between the time-series images having a large motion amount, and only an image of the corresponding portion is output with original time resolution. However, similar to the case where the type of the image is switched, when the interpolation process is stopped or restarted, the variation of the image quality may give a sense of discomfort to the viewer.

Accordingly, the present invention addresses the above-identified, and other issues associated with methods in related art and apparatuses. There is a need for a new and improved image processing apparatus and an image processing method that can smoothly vary an interpolation degree in a switching process of whether or not to execute an image interpolation process or an image interpolation process method, thereby reducing a sense of discomfort felt by a viewer at the time of the switching process.

In order to solve the above issue, according to an embodiment of the present invention, there is provided an image processing apparatus that generates interpolation image signals based on a motion vector between continuously input time-series image signals and increases time resolution. The image processing apparatus includes a feature variation detecting unit that detects a predetermined feature variation between the time-series image signals; a generation time setting unit that sets a generation time of the interpolation image signals; and an interpolation image signal generating unit that generates the interpolation image signals at the generation time set by the generation time setting unit. In addition, when the generation time setting unit sets the generation time after the feature variation of the time-series image signals has been detected by the feature variation detecting unit, the generation time setting unit sets the generation time to approximate an approximation time of any one of the time-series image signals whose times are arranged before and after the generation time.

As such, the image processing apparatus is related to a technology for generating interpolation image signals based on a motion vector between continuously input time-series image signals and increasing time resolution. In particular, since the image processing apparatus includes the feature variation detecting unit, the image processing apparatus has a function of detecting the predetermined feature variation between the time-series image signals. Accordingly, the image processing apparatus that has the above function can detect a change in the types of the time-series image signals, such as a rapid speed change or a rapid image scene change between the continuously input time-series image signals or a time resolution change of the time-series image signals.

Further, since the image processing apparatus includes the generation time setting unit, the image processing apparatus has a function of setting the generation time of the interpolation image signals. With this function, the image processing apparatus can freely set the generation time of the interpolation image signals that are generated between the continuously input time-series image signals. For example, the generation time can be set to an arbitrary time between the two time-series image signals whose times are arranged before and after the generation time when the interpolation image signals are generated. The generation time of each of the interpolation image signals may be set such that the interpolation image signals are uniformly generated between the two time-series image signals. However, when the feature variation is detected in the time-series image signals, it should be noted that the generation times of all the interpolation image signals are not uniformly set.

Further, since the image processing apparatus includes the interpolation image generating unit, the image processing apparatus has a function of generating the interpolation image signals corresponding to the generation time that is set by the generation time setting unit. With this function, the image processing apparatus can generate the interpolation image signals corresponding to the generation time that is arbitrarily set by the generation time setting unit. For example, based on the motion vector between the two time-series image signals whose times are arranged before and after the generation time, image signals (interpolation image signals) that correspond to an image of the generation time are generated from the two time-series image signals. In this case, the interpolation image signals may be generated by not only using the time-series image signals whose times are arranged immediately before and after the generation time as reference image signals but also referring to a motion vector for other time-series image signals or other time-series image signals.

In addition, when the image processing apparatus uses the function of the generation time setting unit to set the generation time after the feature variation of the time-series image signals has been detected by the feature variation detecting unit, the image processing apparatus sets the generation time to approximate the approximation time of any one of the time-series image signals whose times are arranged before and after the generation time. As such, since the generation time is set to approximate the approximation time of any one of the time-series image signals whose times are arranged before and after the generation time, it is possible to smoothly connect boundaries between a smooth high-resolution image where the interpolation image signals are uniformly inserted between the continuous time-series image signals and a low-resolution image where the interpolation image signals are not inserted between the time-series image signals. As a result, it becomes difficult for a viewer to recognize switching between the high-resolution image and the low-resolution image. Even though a plurality of types of time-series image signals having different features are mixed and input, it becomes difficult for the viewer to recognize unnaturalness of the images that are generated at the switching point.

Further, the generation time setting unit may set the generation time, such that an approximation degree of the generation time decreases when a time difference between the time-series image signals whose feature variation has been detected by the feature variation detecting unit and the time-series image signals whose times are arranged before the generation time increases. As such, since the approximation degree decreases as a time difference (passage time) between the time when the feature variation is generated and the generation time (time of the time-series image signal whose time is arranged immediately before the generation time is referred to as a reference point of the generation time) increases, it becomes possible to smoothly connect the boundaries between the low-resolution image and the high-resolution image.

The low-resolution image where the interpolation image signals are not generated corresponds to the case where the generation time is matched with the time of the time-series image signal. Meanwhile, the high-resolution image corresponds to the case where the interpolation image signals are uniformly generated between the time-series image signals. That is, the low-resolution image and the high-resolution image described herein are different from each other in a temporal approximation degree between the interpolation image signal and the time-series image signal. For this reason, if the interpolation image signal and the time-series image signal gradually approximate each other in accordance with the passage time, the variation in the time resolution can be smoothly realized, as described above.

Further, the feature variation detecting unit may detect a time resolution difference between the time-series image signals as the predetermined feature variation. Furthermore, the feature variation detecting unit may detect whether a motion amount between the time-series image signals exceeds a predetermined value as the predetermined feature variation. Furthermore, the feature variation detecting unit may detect image scene switching between the time-series image signals as the predetermined feature variation.

As such, various feature variations are assumed in accordance with the features of the time-series image signals, but the technology that is related to the image processing apparatus can be favorably applied with respect to any feature variations. The feature variation is a representative example where judders may be easily generated in the vicinity of a variation point thereof. For this reason, the technology that is related to the image processing apparatus can be favorably applied with respect to the feature variation, thus, a more remarkable effect is expected.

Further, the generation time setting unit may set the generation time such that an approximation degree of the generation time increases when the motion amount between the time-series image signals increases. Among the feature variations, in the case where the motion amount between the time-series image signals is detected, if the motion amount increases, disturbance may be further easily generated in an image. This is because motion detection precision is lowered in the case where a moving speed of a moving object included in the time-series image signals is excessively fast, thereby generating incorrect interpolation image signals.

In the case where the interpolation image signals are generated based on motion information including an incorrect motion vector, if a distance increases from the time-series image signal corresponding to a base point of the motion vector, an influence by an error of the motion vector may be viewed by the viewer. Accordingly, when the motion amount is large, the influence by the error is suppressed by generating the interpolation image signal to approximate the time-series image signal. If the configuration of the generation time setting unit is used, it is possible to suppress the influence by the error. As a result, it becomes difficult for the viewer to view disturbance of an image even in a portion where the motion amount is large. For example, a method is considered, in which an interpolation process is stopped in a portion where the motion amount is large. In this case, however, since the rapid change in the time resolution is generated, images having unnatural boundary connection may be formed. The configuration of the generation time setting unit is made in consideration of such issues.

In order to solve the above issue, according to another embodiment of the present invention, there is provided an image processing method that generates interpolation image signals based on a motion vector between continuously input time-series image signals and increases time resolution. The image processing method includes the steps of: detecting a predetermined feature variation between the time-series image signals; setting a generation time of the interpolation image signals; and generating the interpolation image signals at the generation time set in the generation time setting step. In addition, in the generation time setting step, when the generation time is set after the feature variation of the time-series image signals has been detected in the feature variation detecting step, the generation time is set to approximate an approximation time of any one of the time-series image signals whose times are arranged before and after the generation time.

In the image processing method, in the feature variation detecting step, the predetermined feature variation is detected between the time-series image signals. Next, in the generation time setting step, the generation time of the interpolation image signals is set. At this time, in generation time setting step, when the generation time is set after the feature variation of the time-series image signals has been detected in the feature variation detecting step, the generation time is set to approximate an approximation time of any one of the time-series image signals whose times are arranged before and after the generation time. Next, in the interpolation image signal generating step, the interpolation image signal that corresponds to the generation time set in the generation time setting step is generated.

As such, in the image processing method, when the generation time is set after the feature variation of the time-series image signals has been detected in the feature variation detecting step, the generation time is set to approximate an approximation time of any one of the time-series image signals whose times are arranged before and after the generation time. For this reason, it is possible to smoothly connect boundaries between a smooth high-resolution image where the interpolation image signals are uniformly inserted between the continuous time-series image signals and a low-resolution image where the interpolation image signals are not inserted between the time-series image signals. As a result, it becomes difficult for a viewer to recognize switching between the high-resolution image and the low-resolution image. Even though a plurality of types of time-series image signals having different features are mixed and input, it becomes difficult for the viewer to recognize unnaturalness of an image that is generated at the switching point.

According to the embodiments of the present invention described above, when whether or not to execute an image interpolation process or an image interpolation process method is switched, an interpolation degree is smoothly varied during a switching process. Accordingly, it is possible to alleviate a sense of discomfort that a viewer feels at the time of switching.

### BRIEF DESCRIPTION OF THE DRAWINGS

FIG. 1 is a diagram illustrating an example of the simple configuration of a display device according to an embodiment of the present invention;

FIG. 2 is a diagram illustrating the functional configuration of a display device according to an embodiment of the present invention;

FIG. 3 is a diagram illustrating an example of an image processing method according to the embodiment;

FIG. 4 is a diagram illustrating an example of an image processing method according to the embodiment;

FIG. 5 is a diagram illustrating a process flow of an image processing method according to the embodiment;

FIG. 6 is a diagram illustrating the functional configuration of a display device according to another embodiment of the present invention;

FIG. 7 is a diagram illustrating an example of an image processing method according to the embodiment;

FIG. 8 is a diagram illustrating a process flow of an image processing method according to the embodiment;

FIG. 9 is a diagram illustrating an example of an image processing method according to the embodiment;

FIG. 10 is a diagram illustrating a process flow of an image processing method according to the embodiment; and

FIG. 11 is a diagram illustrating an example of the hardware configuration of a display device according to an embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### Embodiments

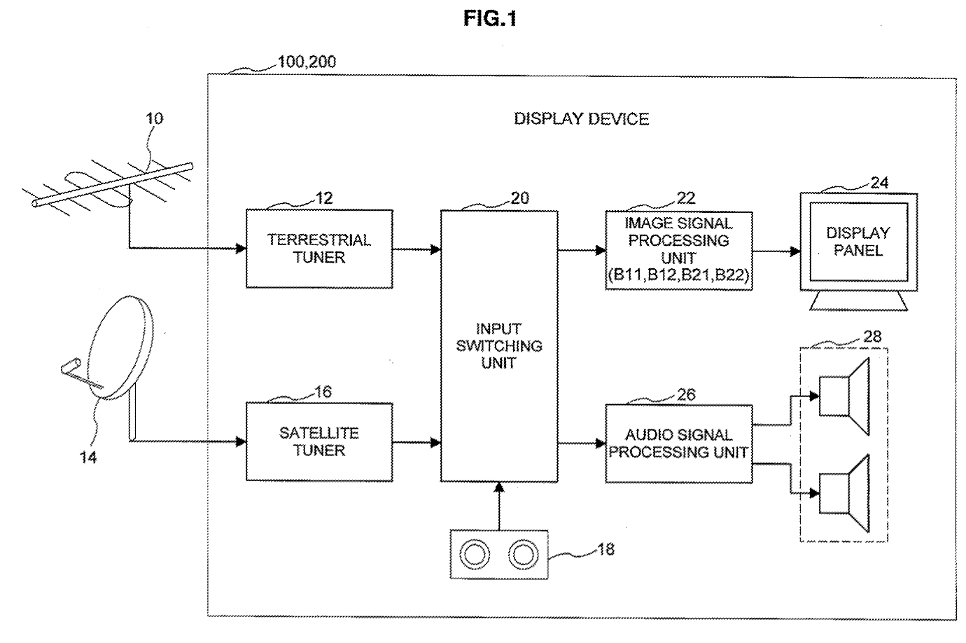

First, before the preferred embodiments of the present invention are described in detail, an example of the hardware configuration of displays devices (corresponding to display devices 100 and 200, which will be described later) where a technology according to the embodiments can be applied will be briefly with reference to FIG. 1. FIG. 1 is a diagram illustrating an example of the hardware configuration of display devices (corresponding to display devices 100 and 200, which will be described later) according to an embodiment of the present invention.

As shown in FIG. 1, each of the display devices 100 and 200 includes a terrestrial broadcasting antenna 10, a terrestrial tuner 12, a satellite broadcasting antenna 14, a satellite tuner 16, an input terminal 18, an input switching unit 20, an image signal processing unit 22, a display panel 24, an audio signal processing unit 26, and an audio output unit 28. The image signal processing unit 22 is an example of an image processing apparatus.

The terrestrial broadcasting antenna 10 is an antenna that is used to receive a terrestrial broadcasting program distributed from a broadcasting station. A broadcasting signal that is received by the terrestrial broadcasting antenna 10 is input to the terrestrial tuner 12. The terrestrial tuner 12 demodulates the broadcasting signal that is received by the terrestrial broadcasting antenna 10 and reproduces a time-series image signal and an audio signal. The time-series image signal and the audio signal that are reproduced by the terrestrial tuner 12 are input to the input switching unit 20.

The satellite broadcasting antenna 14 is an antenna that is used to receive a satellite broadcasting program distributed from a broadcasting station through a broadcasting satellite. The broadcasting signal that is received by the satellite broadcasting antenna 14 is input to the satellite tuner 16. The satellite tuner 16 demodulates the broadcasting signal that is received by the satellite broadcasting antenna 14 and reproduces a time-series image signal and an audio signal. The time-series image signal and the audio signal that are reproduced by the satellite tuner 16 are input to the input switching unit 20.

The input terminal 18 is a terminal that is used to connect an image reproducing device or an audio reproducing device that is disposed outside the display device. Examples of the image reproducing apparatus may include a recording reproducing apparatus, such as a hard disc drive (HDD) recorder, a digital versatile disk (DVD) recorder, a Blu-ray (registered trademark) recorder, or a camcorder, and an image producing apparatus, such as a DVD player or a Blu-ray (registered trademark) player.

Examples of the audio reproducing device may include an audio reproducing apparatus, such as a CD player or a portable music player. Of course, an information processing device, such as a personal computer or a portable information terminal, may be connected to the input terminal, or a recording medium, such as a semiconductor memory or a magnetic recording medium, may be connected to the input terminal. As such, since various devices are connected to the input terminal 18, it is possible to use image data or audio data that is provided by media, in addition to terrestrial broadcasting or satellite broadcasting.

The input switching unit 20 inputs a time-series image signal or an audio signal, which is input from a device connected to the terrestrial tuner 12, the satellite tuner 16 or the input terminal 18, to the image signal processing unit 22 or the audio signal processing unit 26. At this time, the input switching unit 20 can switch a signal input from the terrestrial tuner 12, the satellite tuner 16 or the input terminal 18, by an input operation from a user or a predetermined automatic process. That is, the input switching unit 20 can selectively switch acquisition destinations of signals that are input to the image signal processing unit 22 and the audio signal processing unit 26.

For this reason, the image signal processing unit 22 may continuously receive different types of time-series image signals. For example, a time-series image signal for satellite broadcasting is input to the image signal processing unit after a time-series image signal for terrestrial broadcasting is input, or a time-series image signal for a DVD movie is input to the image signal processing unit after the time-series image signal for terrestrial broadcasting is input. Similar to the image signal processing unit, the audio signal processing unit 26 may continuously receive audio signals from a plurality of input units. Further, in regards to a time-series image signal for the same terrestrial program, a film image signal and a camera image signal may be mixed and input.

The image signal processing unit 22 executes a predetermined signal process on the time-series image signals that are continuously input as described above, and displays the processed time-series image signals on the display panel 24. As the predetermined signal process, for example, the image signal processing unit 22 can generate interpolation image signals from the plurality of input time-series image signals and convert the time resolution of the time-series image signals. The image that is displayed on the display panel 24 after the conversion process is executed becomes a smooth image that has higher time resolution than a time-series image signal stream that is input from the input switching unit 20 and is not yet subjected to the conversion process. These functions of the image signal processing unit 22 correspond to functions of the image processing blocks B11 and B21 and the arithmetic processing blocks B12 and B22, which will be described later.

The display panel 24 is a display unit that displays an image signal input from the image signal processing unit 22. Examples of the display panel 24 may include panels, such as a liquid crystal display (LCD), a plasma display panel (PDP), and an electro-luminescence display (ELD).

The audio signal processing unit 26 executes a predetermined signal process on an audio signal that is input from the input switching unit 20, and inputs the audio signal to the audio output unit 28. Examples of the predetermined signal process may include a process of converting an audio signal compressed and encoded by using various audio encoding methods into an audio signal that can be reproduced by the audio output unit 28. If the audio signal that has been subjected to the conversion process is input, the audio output unit 28 outputs the audio. Examples of the audio output unit 28 may include an audio device, such as a speaker or a headphone.

The example of the configuration of the main components of the display devices 100 and 200 (which will be described later) has been briefly described. The technology according to the embodiments that are described below is mainly related to the function of the image signal processing unit 22 among the components.

### First Embodiment

First, a first embodiment of the present invention will be described. This embodiment relates to an image processing method that generates interpolation image signals based on a motion vector between continuously input time-series image signals and increases time resolution. In particular, this embodiment relates to a technology for making it difficult for a viewer to detect switching of an interpolation process by making generation times of the interpolation image signals not set at an equivalent interval between the time-series image signals, when a feature variation of the time-series image signals is detected.

### [Functional Configuration of Display Device 100]

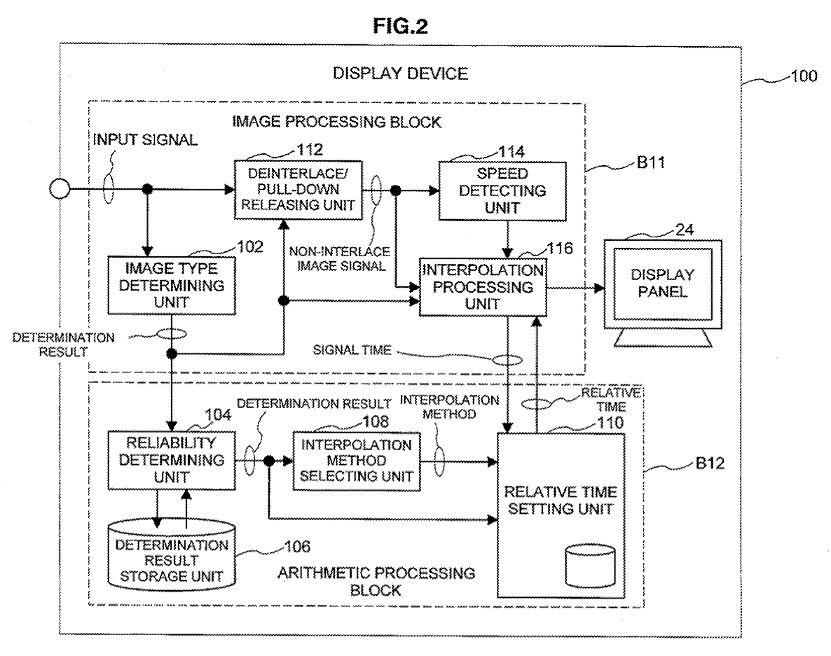

First, the functional configuration of a display device 100 according to this embodiment will be described with reference to FIG. 2. FIG. 2 is a diagram illustrating the functional configuration of the display device 100 according to this embodiment.

As shown in FIG. 2, the display device 100 mainly includes an image processing block B11, an arithmetic processing block B12, and a display panel 24. Among them, the image processing block B11 and the arithmetic processing block B12 correspond to the image signal processing unit 22.

Based on a motion vector between continuously input time-series image signals, the image processing block B11 is a processing block that is used to execute an interpolation process on a stream of the corresponding time-series image signals. Meanwhile, the arithmetic processing block B12 is a processing block that is used to determine a method of an interpolation process that is executed by the image processing block B11 or an interpolated time.

For convenience of explanation, the image processing block B11 and the arithmetic processing block B12 are separated from each other, but may be integrally configured by one processing unit according to an embodiment. Further, a process in each processing block may be a hardware process or a software process. Of course, a combination of the hardware process and the software process may be realized.

Further, the functions of the image processing block B11 are realized by a data signal processing unit 64, an image signal processing unit 66, an OSD circuit 68, a synthetic circuit 70, and a microcomputer 72 among the hardware components, which will be described below. In addition, the functions of the arithmetic processing block B12 are mainly realized by the microcomputer 72. A portion or all of the functions of the above processing blocks may be realized by a CPU 722 based on a program that is recorded in a ROM 724 that constitutes the microcomputer 72.

### (With Respect to Image Processing Block B11)

First, the functional configuration of the image processing block B11 will be described. As shown in FIG. 2, the image processing block B11 mainly includes an image type determining unit 102, a deinterlace/pull-down releasing unit 112, a speed detecting unit 114, and an interpolation processing unit 116. The image type determining unit 102 is an example of a feature variation detecting unit. Further, the interpolation processing unit 116 is an example of an interpolation image signal generating unit.

### (Image Type Determining Unit 102)

The image type determining unit 102 determines types of continuously input time-series image signals (types of images). In addition, information of the types of the images (hereinafter, referred to as determination result) that are determined by the image type determining unit 102 are input to the deinterlace/pull-down releasing unit 112, the interpolation processing unit 116, and a reliability determining unit 104 of the arithmetic processing block B12.

The image type determining unit 102 determines whether the input time-series image signal is a camera image, a film image, or a CG image. When the determination process is executed, the image type determining unit 102 refers to the plurality of input time-series image signals and extracts a feature or regularity detected between the time-series image signals, thereby determining the types of the images. For this reason, during the determination process, the plurality of time-series image signals are used. However, this embodiment is not limited thereto, and the type of the image may be determined based on a single time-series image signal.

In this case, as an example, a method of determining a film image will be specifically described. The film image is input in a state where an image of 24 frames/sec is subjected to a pull-down process to be converted into an image of 60 fields/sec. For example, in the input film image, among the original frames, each odd-numbered frame is converted into two fields and each even-numbered frame is converted into three fields (3-2 film image).

As such, since the two frames are converted into the five fields, the 24 frames/sec are converted into the 60 fields/sec. Based on the above regularity, the image type determining unit 102 determines that the type of images of the time-series image signals having the same feature are a film image, when the time-series image signals are regularly and continuously input in a form of two fields, three fields, two fields, three fields, . . . .

Further, with respect to another image type, such as a CG image, the image type determining unit 102 can detect a feature variation or regularity of the time-series image signals to determine the types of the images. However, the determining method that is described herein is only exemplary, and this embodiment is not limited to the above example and may use another determining method to determine the types of the images.

### (Deinterlace/Pull-Down Releasing Unit 112)

In accordance with the determination result that is input from the image type determining unit 102, the deinterlace/pull-down releasing unit 112 executes a deinterlace process and/or a pull-down process on the continuously input time-series image signals to generate non-interface image signals.

For example, as in the above-described film image, when a plurality of fields that are converted from the same frame are continuously input, an interpolation image that is generated between the fields becomes the same image as the referred fields. Thus, time resolution is not improved. For this reason, the image needs to be returned to the original image by releasing the pull-down process. Accordingly, the deinterlace/pull-down releasing unit 112 executes a pull-down releasing process on a stream of the input time-series image signals, when the result that is determined by the image type determining unit 102 is a film image.

Further, when the determination result of the image type determining unit 102 is a camera image, the deinterlace/pull-down releasing unit 112 executes a deinterlace process on a stream of an input deinterlace image signal to generate a non-interlace image signal. The non-interlace image signal that is generated by the deinterlace/pull-down releasing unit 112 is input to the speed detecting unit 114 and the interpolation processing unit 116.

However, since the interlace image signal may be subjected to the processes of the speed detecting unit 114 and the interpolation processing unit 116 at a rear stage without being converted into the non-interlace image signal, the functional configuration of the deinterlace/pull-down releasing unit 112 can be changed according to an embodiment. With respect to the modification, the technology according to this embodiment can be applied. However, in the description below, it is assumed that the interlace image signal is converted into the non-interlace image signal.

### (Speed Detecting Unit 114)

Based on the time-series image signals that are converted into the non-interlace image signals by the deinterlace/pull-down releasing unit 112, the speed detecting unit 114 detects a motion vector between the time-series image signals. When the motion vector is detected, the speed detecting unit 114 can use various motion detecting methods, such as a block matching method, a phase correlation method, or an optical flow method. Information of the motion vector (motion information) that is detected by the speed detecting unit 114 is input to the interpolation processing unit 116.

### (Interpolation Processing Unit 116)

First, the interpolation processing unit 116 generates interpolation image signals that are used to interpolate the time-series image signals after being converted into the non-interlace image signals, based on the motion information that is detected by the speed detecting unit 114. Further, the interpolation processing unit 116 inserts the generated interpolation image signals between the corresponding time-series image signals and generates image signals that have high time resolution. The image signals that are generated by the interpolation processing unit 116 are input to the display panel 24.

However, the generation time of the interpolation image signal is set by a relative time setting unit 110 of the arithmetic processing block B12 or determined based on the determination result that is input from the image type determining unit 102. The relative time is time that is relatively expressed based on time of the time-series image signal (original image) that is input from the deinterlace/pull-down releasing unit 112. Meanwhile, the generation time that is determined based on the determination result is set to time when interpolation images of the number that is determined according to the image type are arranged at an equivalent interval between the original images. This setting method will be described later.

When the relative time is acquired, the interpolation processing unit 116 may input times of the time-series image signals (hereinafter, referred to as signal times) before and after the generation time of the interpolation image signal to the relative time setting unit 110 to obtain the corresponding relative times. In contrast, the interpolation processing unit 116 may not input the signal times to the relative time setting unit 110 but may acquire relative times associated with the individual signal times from the relative time setting unit 110. This acquisition process is executed in consideration of a delay that is generated when calculating/setting the relative times. The correspondence relationship between the relative times and the time-series image signals may be recognized by the interpolation processing unit 116. However, the acquisition process method is not limited to the above example.

### (Specific Example)

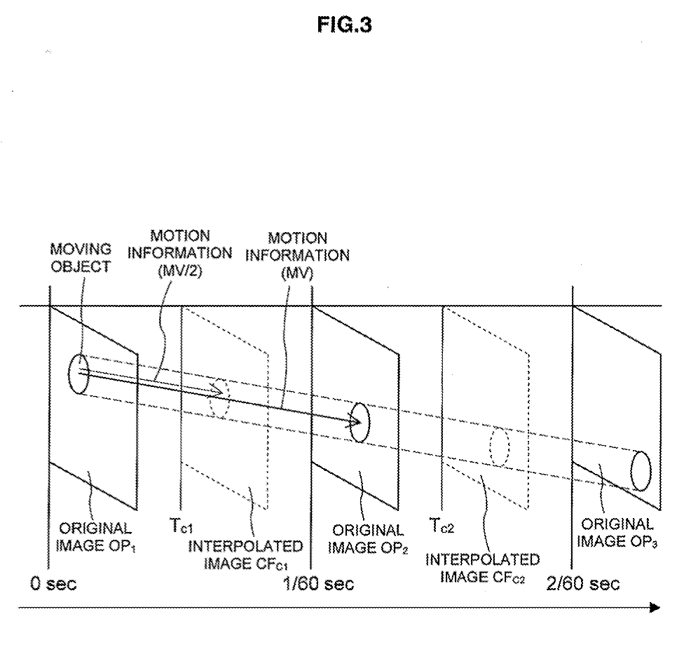

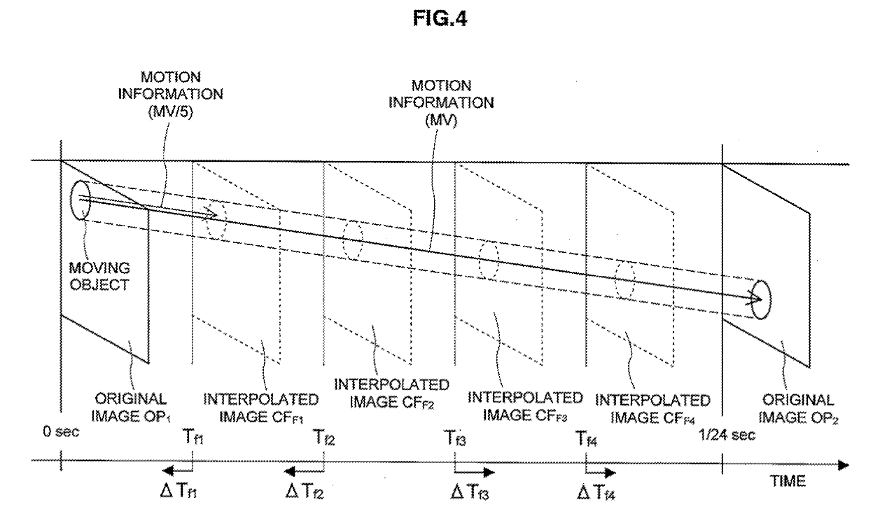

Here, a generation process method of an interpolation image signal will be specifically exemplified with reference to FIGS. 3 and 4. FIG. 3 is a diagram illustrating a generation process method of an interpolation image signal when a time-series image signal stream of a camera image is input. FIG. 4 is a diagram illustrating a generation process method of an interpolation image signal when a time-series image signal stream of a film image is input.

In this case, it is assumed that one or more interpolation image signals are generated by the interpolation processing unit 116 between two continuous time-series image signals (original images OP₁ and OP₂). Further, in this example, it is assumed that executed is a conversion process in which time resolution is converted into time resolution of 120 frames/sec by the interpolation processing unit 116.

As described above, the number of generated interpolation image signals is different between the camera image and the film image. When a camera image that has time resolution of 60 fields/sec is input (refer to FIG. 3), the number of interpolation image signals that are generated by the interpolation processing unit 116 is one (interpolation image CF_{C1}). Meanwhile, when a film image that has time resolution of 24 frames/sec is input (refer to FIG. 4), four interpolation image signals (interpolation images CF_{F1}, CF_{F2}, CF_{F3}, and CF_{F4}) are generated by the interpolation processing unit 116. The interpolation processing unit 116 can generate an interpolation image signal at an arbitrary time between the original images OP₁ and OP₂. However, an interpolation method that can form the smoothest image is a method in which the interpolation image signals are uniformly arranged at an equivalent interval between the original images OP₁ and OP₂.

In the example of FIG. 3, an interpolation image CF_{C1} is arranged at the relative time T_{C1} that uses time of the original image OP₁ as a base (0 sec). As described above, when the interpolation method that forms the smoothest image is used, the relative time T_{C1} becomes 1/120 sec. In this case, first, the interpolation processing unit 116 calculates motion information between the original image OP₁ and the interpolation image CF_{C1}, based on motion information (motion vector MV) between the original images OP₁ and OP₂.

The motion information (MV/2) between the original image OP₁ and the interpolation image CF_{C1} is determined based on the relative time T_{C1} when the interpolation image CF_{C1} is arranged. In the case of T_{C1}= 1/120 [sec], the interpolation processing unit 116 calculates a motion vector MV/2 by dividing a motion vector MV of a moving object (block) included in the original images OP₁ and OP₂ by two, and determines the location of the moving object in the interpolation image CF_{C1} using the motion vector MV/2.

Using another original image OP₃ as a reference image, the interpolation image CF_{C1} may be generated based on motion information corresponding to the original image OP₃. Further, the interpolation image CF_{C1} may be generated based on a plurality of reference images.

In the example of FIG. 4, the interpolation images CF_{F1}, CF_{F2}, CF_{F3}, and CF_{F4} are arranged at the relative times T_{f1}, T_{f2}, T_{f3}, and T_{f4} that use the time of the original image OP₁ as a reference (0 sec). In the case of the interpolation method that forms the smoothest image, the relative times T_{f1}, T_{f2}, T_{f3}, and T_{f4} become 1/120 sec, 2/120 sec, 3/120 sec, and 4/120 sec, respectively.

First, the interpolation processing unit 116 calculates motion information between the original image OP₁ and the interpolation image CF_{F1}, based on motion information (motion vector MV) between the original image OP₁ and the interpolation image OP₂. In the same way, the interpolation processing unit 116 calculates motion information between the original image OP₁ and each of the interpolation images CF_{F2}, CF_{F3}, and CF_{F4}. This calculation method is the same as that in the case of FIG. 3. In addition, the interpolation processing unit 116 generates the interpolation images CF_{F1}, CF_{F2}, CF_{F3}, and CF_{F4} based on the calculated motion information.

However, the interpolation processing unit 116 can generate the interpolation images CF_{F1}, CF_{F2}, CF_{F3}, and CF_{F4} at the relative times that are closer to the original image OP₁ or the original image OP₂ than the relative times T_{f1}, T_{f2}, T_{f3}, and T_{f4} arranged at an equivalent interval. For example, the interpolation processing unit 116 can generate the interpolation image CF_{F1} of the relative time (T_{f1}+ΔT_{f1}) (ΔT_{f1}<0).

In this case, the interpolation processing unit 116 generates the interpolation image CF_{F1} based on a motion vector that is obtained by multiplying the motion vector MV between the original image OP₁ and the original image OP₂ by (T_{f1}+ΔT_{f1})[sec]/( 1/24)[sec]. This is applicable to the interpolation images CF_{F2}, CF_{F3}, and CF_{F4}. The shift amount ΔT_{fk} (k=1 to 4) from the relative times T_{fk} (k=1 to 4) that are arranged at an equivalent interval will be described later.

In the above example, the time of the input time-series image signal (original image OP₁) is used as a base of the relative time, but may not be used as the base of the relative time. For example, if an interpolation method for each image type is specified, the relative times may be expressed based on the relative times T_{fk} (k=1 to 4) (hereinafter, uniform times) that are uniformly arranged at an equivalent interval. According to this expression method, a shift amount ΔT_{fk} (k=1 to 4) (that, is, an “approximation degree” with respect to the input time-series image signal (the original image OP₁ or the original image OP₂)) from the uniform time becomes clear. However, the expression of the relative times is not limited to the above example.

The functional configuration of the image processing block B11 has been described. Next, the functional configuration of the arithmetic processing block B12 will be described in detail.

### (With Respect to Arithmetic Processing Block B12)

Referring back to FIG. 2, the arithmetic processing block B12 includes a reliability determining unit 104, a determination result storage unit 106, an interpolation method selecting unit 108, and a relative time setting unit 110. The relative time setting unit 110 is an example of the generation time setting unit.

### (With Respect to Reliability Determining Unit 104 and Determination Result Storage Unit 106)

The reliability determining unit 104 determines the reliability of a determination result that is input from the image type determining unit 102. When it is determined that the input determination result is reliable, the reliability determining unit 104 inputs the determination result to the interpolation method selecting unit 108 and the relative time setting unit 110.

The determination result is input to the interpolation method selecting unit 108 and the relative time setting unit 110. At this time, the determination result is input in a state where the determination result is associated with the time of the time-series image signal immediately before or immediately after the image type is switched. Since the determination result is associated with the time of the time-series image signal, the interpolation method selecting unit 108 and the relative time setting unit 110 can recognize information that indicates when the image type is switched and an image type into which the corresponding image type is converted.

Further, the reliability determining unit 104 records the determination result in the determination result storage unit 106, when the determination result is input from the image type determining unit 102. For this reason, the reliability determining unit 104 can refer to the past determination results that are accumulated in the determination result storage unit 106 in time-series and determine the reliability of the determination result that is input from the image type determining unit 102.

For example, the reliability determining unit 104 records in the determination result storage unit 106 a determination result (first determination result) with respect to the time-series image signal (original image OP₁) immediately before the image type is switched and the time-series image signal (original image OP₂) immediately after the image type is switched. Further, the reliability determining unit 104 acquires from the image type determining unit 102 a determination result (second determination result) with respect to the time-series image signal (original image OP₃) of the time that is later than the times of the original image OP₁ and the original image OP₂.

In addition, the reliability determining unit 104 reads out the first determination result that is recorded in the determination result storage unit 106 and determines whether the first determination result and the second determination result are matched with each other. As a result, when it is determined that the first determination result and the second determination result are matched with each other, the reliability determining unit 104 determines that the reliability of the corresponding determination result is high. In this example, the two determination results are compared, but the present invention is not limited thereto. That is, three or more determination results may be compared and the reliability of the determination result may be determined.

Further, when a plurality of image type determining units 102 are provided, the reliability determining unit 104 can synthesize a plurality of determination results that are input from the image type determining units 102 and determine the reliability of the determination result. For example, the reliability determining unit 104 may compare the plurality of determination results, and determine that the reliability is high, when the plurality of determination results are matched with each other. Of course, the reliability determining unit 104 may refer to the past determination results as determination material and comprehensively determine the reliability.

As such, in the case where predetermined precision is requested at the time of determining reliability, a plurality of determination results are used, and a plurality of processes are needed. For this reason, when the reliability is determined, a predetermined process time is needed. Further, in order to increase reliability determination precision, a large amount of determination results need to be used. In this case, time may be needed by a frame period until a predetermined amount of time-series image signals are input. Accordingly, it may be generally difficult to immediately determine the type of the image immediately after the type of the image is switched. For this reason, during the determination process, the interpolation process is not executed or the interpolation process that is not suitable for the type of the image is executed, thereby generating judders.

### (Interpolation Method Selecting Unit 108)

The interpolation method selecting unit 108 receives the determination result whose high reliability has been confirmed by the reliability determining unit 104 and selects an interpolation method that corresponds to the determination result. For example, when the determination result is a camera image, the interpolation method selecting unit 108 selects the number of interpolation image signals that are suitable for the camera image and the generation time of the interpolation image signals. Further, even in the case where the determination result is a film image or a CG image, the number of interpolation image signals and the generation time of the interpolation image signals are selected using the same method as the above method.

As described above, in order to realize the smoothest image, the interpolation image signals are preferably generated at an equivalent interval between the time-series image signals. Accordingly, the interpolation method selecting unit 108 select as interpolation method the number of interpolation image signals and the generation time of the interpolation image signals in order to allow the interpolation image signals to be arranged at an equivalent interval, in accordance with a targeted time resolution value after the interpolation process. In addition, the interpolation method selecting unit 108 inputs information of the selected interpolation method to the relative time selecting unit 110.

### (Relative Time Setting Unit 110)

The relative time setting unit 110 sets the relative time to generate the interpolation image signal, based on the determination result that is input from the reliability determining unit 104 and the information of the interpolation method that is input from the interpolation method selecting unit 108. In addition, the relative time setting unit 110 inputs the set relative time to the interpolation processing unit 116 of the image processing block B11.

Further, the relative time setting unit 110 may input the relative time corresponding to the designated signal time to the interpolation processing unit 116 in accordance with a setting request from the interpolation processing unit 116, or input the relative time associated with the time of each time-series image signal to the interpolation processing unit 116, regardless of the setting request from the interpolation processing unit 116. Even though any one of the above methods is used, the relative time for each time-series image signal is accurately notified to the interpolation processing unit 116.

In this embodiment, a setting method of the relative time that is set by the relative time setting unit 110 is important. Accordingly, the corresponding setting method will be described in detail below.

First, the relative time setting unit 110 can recognize the time when the type of the image has been varied based on the determination result that is input from the reliability determining unit 104. Accordingly, the relative time setting unit 110 sets the relative time based on the passage time that uses the time when the type of the image has been varied as a base. At this time, the relative time setting unit 110 sets the relative time to “finally” become the equivalent-interval generation time (hereinafter, referred to as target time) of the interpolation image signal, based on the interpolation method that is selected by the interpolation method selecting unit 108.

As specifically exemplified below, the relative time setting unit 110 does not immediately set the relative time, which is set after the type of the image has been varied, to the target time. The relative time setting unit 110 sets the relative time such that the relative time gradually approximate the target time in accordance with the passage time, using a vertical synchronization period of the time-series image signal as a unit. A specific example of the above setting method will be described below.

### (Specific Example)

As an example, the case where the relative time is expressed by a linear function of the passage time is considered. As the specific example, the case shown in FIG. 4 is assumed. That is, it is assumed that the four interpolation images CF_{F1}, CF_{F2}, CF_{F3}, and CF_{F4} are generated between the two original images OP₁ and OP₂. However, it is assumed that the original image OP₁ is a time-series image signal of the time after the time of the time-series image signal immediately after the type of the image has varied has passed by a predetermined time t (frame unit), and the time of the original image is a reference (0 sec) of the relative time. In addition, it is assumed that the relative time of the original image OP₂ is 1/24 sec.

Further, an interpolation processing method that improves time resolution to 1/120 sec is considered. In addition, it is assumed that the relative time setting unit 110 receives a target time T_{fk}=k/120 of the interpolation image CF_{Fk} (k=1 to 4) as information of an interpolation method from the interpolation method selecting unit 108.

In this case, with respect to the passage time t (frame unit) from the original Image OP₁, for example, the relative time (T_{fk}+ΔT_{fk}) of the interpolation image CF_{Fk} (k=1 to 4) is set as represented by the following Eqs. (1) to (4).

In the case of an example that is shown by the following Eqs. (1) to (4), the interpolation images CF_{F1} and CF_{F2} that are close to the original image OP₁ are set such that the relative times thereof gradually increase with respect to the passage time t. Meanwhile, the interpolation images CF_{F3} and CF_{F4} that are close to the original image OP₂ are set such that the relative times thereof gradually decrease with respect to the passage time t. In this example, the relative time is set such that a period of 60 frame is needed until the relative time (T_{fk}+ΔT_{fk}) of each interpolation image CF_{FK} (k=1 to 4) is matched with the target time T_{fk}. Accordingly, each relative time becomes matched with the target time after the period of 60 frames.

Further, if the following Eqs. (1) and (2) are compared with each other, the relative time of the interpolation image CF_{F1} that is closer than the original image OP₁ than the interpolation image CF_{F2} is set such that the inclination A₁ with respect to the passage time t decreases. Each of the inclinations A₁ and A₂ indicates a variation amount of distance by which each of the interpolation images CF_{F1} and CF_{F2} becomes distant from the original image OP₁ in accordance with the progress of the passage time t. That is, the following Eqs. (1) and (2) show a setting method that sets a relative time, such that the interpolation image CF_{F2} becomes distant from the original image OP₁ as time passes.

In the same way, if the following Eqs. (3) and (4) are compared with each other, the relative time of the interpolation image CF_{F4} that is closer than the original image OP₂ than the interpolation image CF_{F3} is set such that the inclination A₄ with respect to the passage time t decreases. Each of the inclinations A₃ and A₄ indicates a variation amount of distance by which each of the interpolation images CF_{F3} and CF_{F4} becomes distant from the original image OP₂ in accordance with the progress of the passage time t. That is, the following Eqs. (3) and (4) show a setting method that sets a relative time, such that the interpolation image CF_{F3} becomes distant from the original image OP₂ as time passes.

RELATIVE TIME(T_{f1}+ΔT_{f1})=A₁*t+B₁ (1)

RELATIVE TIME(T_{f2}+ΔT_{f2})=A₂*t+B₂ (2)

RELATIVE TIME(T_{f3}+ΔT_{f3})=A₃*t+B₃ (3)

RELATIVE TIME(T_{f4}+ΔT_{f4})=A₄*t+B₄ (4)

A₁=1/(120*60)[sec], B₁=0 [sec]

A₂=2/(120*60)[sec], B₂=0 [sec]

A₃=−2/(120*60)[sec], B₃= 1/24 [sec]

A₄=−1/(120*60)[sec], B₄= 1/24 [sec]

As described above, the relative time setting unit 110 can set the relative time using a linear function of the passage time. However, this embodiment is not limited thereto. For example, the relative time may be set using a high-dimensional function of a quadratic function or more or an exponential function. Alternatively, the relative time may be set using an arbitrarily set function.

A method of generalizing Aₖ*t (k=1 to 4) to an arbitrary function fₖ(t) is also considered. At this time, the function is defined such that the conditions {0<f₁(t)≦f₂(t); f₁(0)=f₂(0)=0; f₁(60)= 1/120 [sec], f₂ (60)= 2/120 [sec]}, and {f₃(t)≦f₂(t)<0 [sec]; f₃(0)=f₄(0)=0 [sec]; f₃(60)=− 2/120 [sec], f₄(60)=− 1/120 [sec]} are satisfied.

As such, the type of function may be arbitrary. However, the type of the function is set such that, when the pass time t=0 is satisfied, all the relative times are matched with the times of the original images, and when the pass time t reaches a predetermined frame period (t=60), all the relative times are matched with the target times. In the above description, the type of the function is represented as a “function”. As such, the relative time setting unit 110 may be configured to operate and output the relative time with respect to the input of the passage time based on the predetermined function type. However, the relative time setting unit 110 may be configured such that a table corresponding to the “function” is held and the predetermined relative times are set by referring to the table.

The functional configuration of the display device 100 according to this embodiment has been described. As described above, the display device 100 according to this embodiment can set the relative time to generate the interpolation image to approximate the time of the original image, after the switching portion of the type of the image where judders may be easily generated. Further, the display device 100 can set the relative time such that the relative time gradually approximates the target time in accordance with the size of the passage time using the time of the original image where the type of the image has been varied as a base.

For this reason, even though the judders are generated at a point of time when the type of the image is switched, since the corresponding image gradually varies to the smooth image after the interpolation process, it becomes difficult for a viewer to recognize the switching portion of the interpolation process. As a result, it becomes difficult for the viewer to recognize a variation point of time between the images whose types are different from each other, which results in realizing display that maximally implements smoothness of each image.

### [With Respect to Image Processing Method]

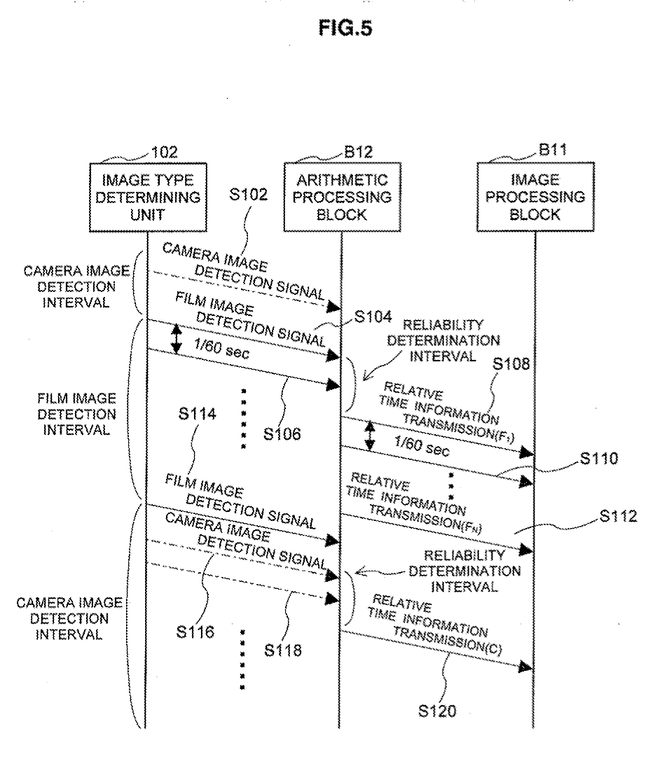

Next, a process flow of an image processing method according to this embodiment will be described with reference to FIG. 5. FIG. 5 is a diagram illustrating a process flow of an image processing method according to this embodiment. However, it is assumed that a time-series image signal of a camera image is input to the display device 100 at a first stage.

First, if a stream of the time-series image signal is input to the display device 100, the type of the image is determined by the image type determining unit 102. When the camera image is detected by the image type determining unit 102, as a determination result that indicates the camera image, a camera image detection signal is input to the arithmetic processing block B12 (S102). At this time, the type of the image of the time-series image signal does not vary as it is the camera image, the arithmetic processing block B12 may not input information about the interpolation method to the image processing block B11. As such, during a period (camera image detection interval) where the time-series image signal of the camera image is continuously input, the interpolation method by the image processing block B11 is not changed.

At any point of time, when the film image is detected by the image type determining unit 102 (film image detection interval), as a determination result that indicates the film image, the film image detection signal is input to the arithmetic processing block B12 (S104). If the film image detection signal is input, the reliability of the determination result is determined by the arithmetic processing block B12. During the reliability determination process, (reliability determination interval), a plurality of film image detection signals are input to the arithmetic processing block B12 (S106). These film image detection signals are input in a frame period unit of a time-series Image signal ( 1/60 [sec]).

If the reliability of the determination result of the image type is confirmed using the film image detection signals, the relative time is set by the arithmetic processing block B12, and the relative time information F₁ is transmitted to the image processing block B11 (S108).

The relative time information (Fₙ (n=1 to N) is generated whenever the film image detection signals are continuously input from the image type determining unit 102, and transmitted to the image processing block B11 (S110 and S112). At this time, the relative time that is indicated by the relative time information (Fₙ (n=1 to N) is set based on the functions shown in the above Eqs. (1) to (4).

After the relative time information F_{N} of the predetermined number N is transmitted, the arithmetic processing block B12 completes generation and transmission of the relative time information. The predetermined number N is the number of frames that are needed until the relative time is matched with the target time. Accordingly, in the case of the example shown in the above Eqs. (1) to (4), the predetermined number N becomes 60. If the number of transmitted relative time information becomes the predetermined number N, the relative time and the target time becomes matched with each other and each relative time becomes uniformly arranged at an equivalent interval between the original images.

That is, the time when the interpolation image is generated is set to the time that is most suitable for the film image. Accordingly, the image processing block B11 continuously executes the interpolation process while maintaining the setting. For this reason, the arithmetic processing block B12 may not perform generation and transmission of the relative time information, even though the film image detection signals are continuously input from the image type determining unit 102 (S114).

Then, at any point of time, when the camera image is detected again by the image type determining unit 102, as a determination result that indicates the camera image, the camera image detection signal is input to the arithmetic processing block B12 (S116). If the camera image detection signal is input, the reliability of the determination result is determined by the arithmetic processing block B12.

During the reliability determination process (reliability determination interval), a plurality of camera image detection signals are input to the arithmetic processing block B12 (S118). If the reliability of the determination result of the image type is confirmed using the camera image detection signals, the relative time is set by the arithmetic processing block B12, and the relative time information C is transmitted to the image processing block B11 (S120).

However, the relative time information C, which is transmitted when a variation is made from the film image to the camera image, is information of the target time that is suitable for the camera image. The reason why the information of the target time is transmitted is to prevent unnatural motion from being generated between the images by continuously executing the interpolation process suitable for the film image, in a state where a stream of the time-series image signal is in a form of the camera image.

That is, the interpolation method is preferably switched into an interpolation method that is suitable for the camera image immediately after the variation is made from the film image to the camera image. If the relative time information C of the camera image is transmitted, the image processing block B11 executes an image process on a stream of the time-series image signal using an interpolation method suitable for the camera image and outputs the process result, during a camera image detection interval.

The process flow of the image processing method according to this embodiment has been described. As described above, according to the image processing method according to this embodiment, the relative time information is generated by the arithmetic processing block B12 in accordance with the type of the image that is detected by the image type determining unit 102, and the interpolation process is executed by the image processing block B11 based on the relative time.

At that time, in the arithmetic processing block B12, the relative time is set such that the variation is gradually made from an image having judders generated in accordance with the switching of the type of the image to the image. As a result, it is possible to alleviate a sense of discomfort that the viewer feels due to the rapid change in the interpolation process.

As described above, if the technology according to the first embodiment of the present invention is applied, it is possible to alleviate a sense of discomfort that may be given to the viewer due to the rapid change in the interpolation method according to the variation in the image type. Further, this embodiment targets the variation in the interpolation method according to the variation in the image type. However, a situation where image switching from the image where the judders are generated to the smooth Image is generated is not limited thereto. For example, even when the motion amount between the continuous time-series image signals is large, the same situation may be generated. The technology according to the embodiment of the present invention can correspond to the above-described situation. Accordingly, an embodiment (second embodiment) that corresponds to the above situation will be described below.

### Second Embodiment

The second embodiment of the present invention will be described. As described above, this embodiment corresponds to the case where the technology according to the embodiment of the present invention is applied to a situation where disturbance occurs in an interpolation image signal due to the rapid change in the motion or scene. In this situation, a method where an interpolation process is temporarily stopped and the time-series image signal displayed at the previous time is displayed again is mainly used. At this time, the judders may be abruptly generated or the rapid change may be generated from the original image to the smooth image, which may give a sense of discomfort to the viewer. Accordingly, an image processing method that can alleviate the sense of discomfort will be described in detail below.

### [Functional Configuration of Display Device 200]

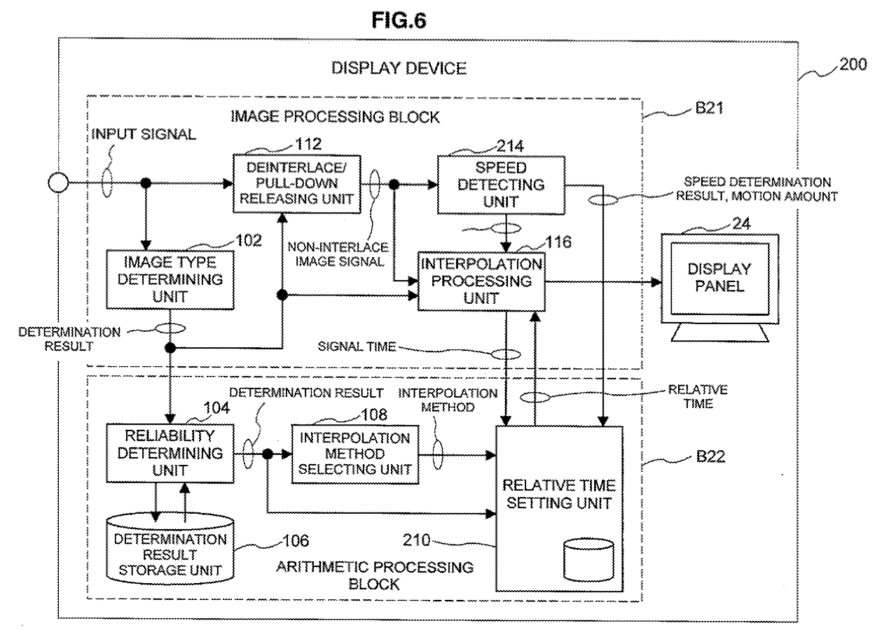

First, the functional configuration of the display device 200 according to this embodiment will be described with reference to FIG. 6. FIG. 6 is a diagram illustrating the functional configuration of a display device 200 according to this embodiment. However, the constituent elements that are substantially the same as those of the display device 100 according to the above-described first embodiment are denoted by the same reference numerals, and the detailed description thereof will be omitted.

As shown in FIG. 6, the display device 200 mainly includes an image processing block B21, an arithmetic processing block B22, and a display panel 24. Among them, the image processing block B21 and the arithmetic processing block B22 correspond to the image signal processing unit 22.

For convenience of explanation, the image processing block B21 and the arithmetic processing block B22 are separated from each other, but may be integrally configured by one processing unit according to an embodiment. Further, a process in each processing block may be a hardware process or a software process. Of course, a combination of the hardware process and the software process may be realized.

Further, the functions of the image processing block B21 are realized by a data signal processing unit 64, an image signal processing unit 66, an OSD circuit 68, a synthetic circuit 70, and a microcomputer 72 among the hardware components, which will be described in detail below. In addition, the functions of the arithmetic processing block B22 are mainly realized by the microcomputer 72. A portion or all of the functions of the processing blocks may be realized by a CPU 722 based on a program that is recorded in a ROM 724 that constitutes the microcomputer 72.

### (With Respect, to Image Processing Block B21)

The image processing block B21 mainly includes an image type determining unit 102, a deinterlace/pull-down releasing unit 112, a speed detecting unit 214, and an interpolation processing unit 116. However, the display device 200 according to the second embodiment is different from the display device 100 according to the first embodiment in that functions of the speed detecting unit 214. Accordingly, only the functional configuration of the speed detecting unit 214 will be described in detail. The speed detecting unit 214 is an example of a feature variation detecting unit.

### (Speed Detecting Unit 214)

Based on the time-series image signals that are converted into the non-interlace image signals by the deinterlace/pull-down releasing unit 112, the speed detecting unit 214 detects a motion vector between the time-series image signals. When the motion vector is detected, the speed detecting unit 214 can use various motion detecting methods, such as a block matching method, a phase correlation method, or an optical flow method. The motion vector is an example of motion information.

Further, the speed detecting unit 214 may be configured to calculate a total amount of average values or middle values of the lengths of motion vectors of time-series image signals that are calculated for each pixel or for every predetermined block. The total amount indicates a motion amount between two time-series image signals.

Further, the speed detecting unit 214 may be configured to synthesize the motion vectors of the time-series image signals that are calculated for each pixel or for every predetermined block and generate a synthesis vector, and calculate the length and direction of the synthesis vector. At this time, the speed detecting unit 214 may be configured to apply a predetermined weight to each motion vector to generate a synthesis vector and calculate the length of the synthesis vector. The length of the synthesis vector also indicates the motion amount between the two time-series image signals.

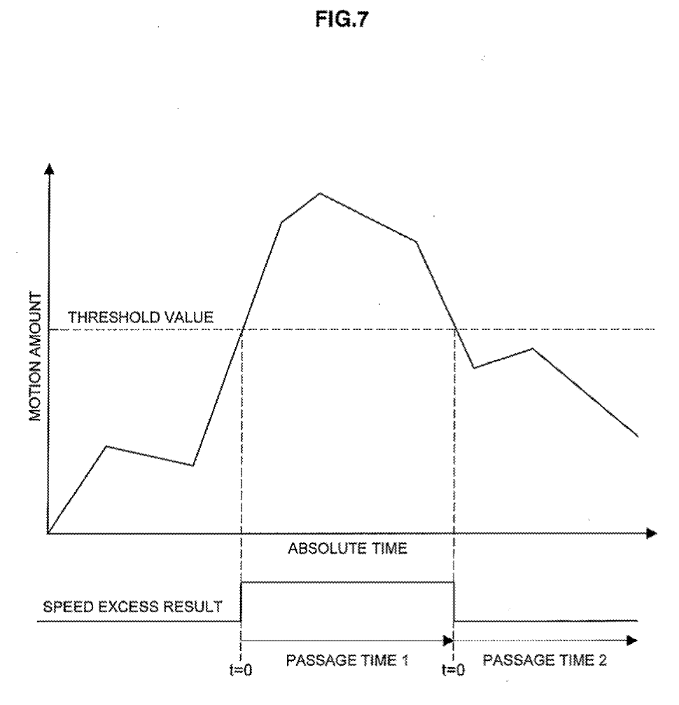

If the above method is used to calculate the motion amount, the speed detecting unit 214 determines whether the motion amount exceeds a predetermined threshold value. The threshold value depends on setting of motion detection precision (a size of a block and a size of a search area). This determination process will be specifically described with reference to FIG. 7. FIG. 7 is a diagram illustrating a speed determination process method according to this embodiment.

FIG. 7 exemplifies a graph of a motion amount detected by the speed detecting unit 214 and a speed excess result calculated by the speed detecting unit 214.

First, a graph of the motion amount is referred to. In the example shown in FIG. 7, the motion amount increases as the absolute time passes and exceeds the predetermined threshold value at any point of time. Further, if the time passes, the motion amount decreases at any point of time and falls below the threshold value. In this case, the speed detecting unit 214 determines that the speed has been exceeded during a period from a point of time when the motion amount exceeds the threshold value to a point of time when the motion amount falls below the threshold value.

The determination result is represented by a speed excess result shown at a lower stage in the drawing. In the corresponding drawing, the speed excess result becomes H (excess) at a point of time when the motion amount exceeds a threshold value, and the speed excess result becomes L (non-excess) at a point of time when the motion amount falls below the threshold value.

The speed detecting unit 214 measures the passage time (passage time 1) using a point of time when the speed excess result becomes H as a reference. The passage time 1 ends at a point of time when the speed excess result becomes L. Further, the speed detecting unit 214 measures a passage time (passage time 2) using a point of time when the speed excess result becomes L as a reference. In addition, the speed determination result, and the passage times and the motion amount are input to the relative time setting unit 210 of the arithmetic processing block B22 by the speed detecting unit 214.

Referring back to FIG. 6, as described above, the motion amount that is calculated by the speed detecting unit 214 and the speed determination result are input to the relative time setting unit 210 of the arithmetic processing block B22. Further, the motion information that is detected by the speed detecting unit 214 is input to the interpolation processing unit 116. The motion amount and the speed determination result are input to the relative time setting unit 210 by the speed detecting unit 214, even when the type of the image is not switched.

Next, the functional configuration of the arithmetic processing block B22 will be described.

### [With Respect to Arithmetic Processing Block B22]

The arithmetic processing block B22 includes a reliability determining unit 104, a determination result storage unit 106, an interpolation method selecting unit 108, and a relative time setting unit 210. The display device 200 according to the second embodiment is different from the display device 100 according to the first embodiment in the functions of the relative time setting unit 210. Accordingly, only the functional configuration of the relative time setting unit 210 will be described in detail. The relative time setting unit 210 is an example of the generation time setting unit.

### (Relative Time Setting Unit 210)

The relative time setting unit 210 sets the relative time to generate the interpolation image signal, based on a determination result that is input from the reliability determining unit 104, information of an interpolation method that is input from the interpolation method selecting unit 108, and the motion amount calculated by the speed detecting unit 214 and the speed determination result. In addition, the relative time setting unit 210 inputs the set relative time to the interpolation processing unit 116 of the image processing block B21.

Further, the relative time setting unit 210 may input a relative time corresponding to the designated signal time to the interpolation processing unit 116 in accordance with a setting request from the interpolation processing unit 116, or input the relative time associated with the time of each time-series image signal to the interpolation processing unit 116, regardless of the setting request from the interpolation processing unit 116. Even though any one of the above methods is used, the relative time for each time-series image signal is accurately notified to the interpolation processing unit 116.

In this embodiment, the setting method of the relative time that is set by the relative time setting unit 210 is important. Accordingly, the corresponding setting method will be described in detail below.

First, the relative time setting unit 210 can recognize the time when the speed has been exceeded based on the speed determination result input from the speed detecting unit 214 and the motion amount. Accordingly, the relative time setting unit 210 sets the relative time based on the passage time from the time when the speed has been exceeded. At this time, the relative time setting unit 210 sets the relative time to “finally” become the equivalent-interval generation time (hereinafter referred to as target time) of the interpolation image signal, based on the interpolation method that is selected by the interpolation method selecting unit 108.

As specifically exemplified below, the relative time setting unit 210 does not immediately set the relative time, which is set after the type of the image has been varied, to the target time. The relative time setting unit 210 sets the relative time such that the relative time gradually approximate the target time in accordance with the passage time, using a vertical synchronization period of the time-series image signal as a unit. A specific example of the above setting method will be described below.

### (First Specific Example: Speed Non-Excess→Speed Excess)

As an example, the case where the relative time is expressed by a linear function with respect to the passage time 1 after the speed excess is considered. As the specific example that corresponds to FIG. 4, it is assumed that the four interpolation images CF_{F1}, CF_{F2}, CF_{F3}, and CF_{F4} are generated between the two original images OP₁ and OP₂, and the interpolation process is continuously executed until each interpolation image is matched with the original image OP₁ or the original image OP₂. In addition, an example shown in FIG. 7 is assumed as a variation of the motion amount. However, it is assumed that a target time of the interpolation image CF_{Fk} (k=1 to 4) is (T_{f1}+ΔT_{f1})=(T_{f2}+ΔT_{f2})=0 [sec], and the relative time is (T_{f3}+ΔT_{f3})=(T_{f4}+ΔT_{f4})= 1/24 [sec].

Further, it is assumed that the original image OP₁ is an image of a time-series image signal of the time when the predetermined time t (frame unit) has passed from the time of the time-series image signal immediately after the speed exceed is generated (passage time 1=0), and the time thereof is a reference (0 sec) of the relative time. In this case, with respect to the passage time t (frame unit) from the original image OP₁, for example, the relative time (T_{fk}+ΔT_{fk}) of the interpolation image CF_{Fk} (k=1 to 4) is set as represented by the following Eqs. (5) to (8).

In the following Eqs. (5) to (8), the reason why the Bₖ (k=1 to 4) is defined as (a value of the relative time (T_{fk}+ΔT_{fk}) in the passage time 1=0) is because it may be assumed that the relative time is being set in accordance with the switching of the type of the image. In this case, instead of the time T_{fk} of the interpolation images CF_{Fk} (k=1 to 4) that are arranged at an equivalent interval, the relative time (T_{fk}+ΔT_{fk}) of each interpolation image in the passage time 1=0 becomes a setting reference. Even during another relative time setting process, continuity of the relative time information is maintained by the above setting.

If the following Eqs. (5) and (6) are compared with each other, the relative time of the interpolation image CF_{F1} that is closer to the original image OP₁ than the interpolation image CF_{F2} is set such that the inclination A₁ with respect to the passage time t is small. Each of the inclinations A₁ and A₂ indicates a variation amount of distance by which each of the interpolation images CF_{F1} and CF_{F2} approximates the original image OP₁ in accordance with the progress of the passage time t. That is, the following Eqs. (5) and (6) show a setting method that sets a relative time, such that the interpolation image CF_{F2} further approximates the original image OP₁ as time passes.

In the same way, if the following Eqs. (7) and (8) are compared with each other, the relative time of the interpolation image CF_{F4} that is closer to the original image OP₂ than the interpolation image CF_{F3} is set such that the inclination A₄ with respect to the passage time t is small. Each of the inclinations A₃ and A₄ indicates a variation amount of distance by which each of the interpolation images CF_{F3} and CF_{F4} approximates the original image OP₂ in accordance with the progress of the passage time t. That is, the following Eqs. (7) and (8) show a setting method that sets a relative time, such that the interpolation image CF_{F3} further approximates the original image OP₂ as time passes.

RELATIVE TIME(T_{f1}+ΔT_{f1})=A₁*t+B₁ (5)

RELATIVE TIME(T_{f2}+ΔT_{f2})=A₂*t+B₂ (6)

RELATIVE TIME(T_{f3}+ΔT_{f3})=A₃*t+B₃ (7)

RELATIVE TIME(T_{f4}+ΔT_{f4})=A₄*t+B₄ (8)

A₁=−1/(120*60)[sec]

A₂=−2/(120*60)[sec]

A₃=2/(120*60)[sec]

A₄=1/(120*60)[sec]

B₁=(RELATIVE TIME(T_{f1}+ΔT_{f1}) at PASSAGE TIME1=0)[sec]

B₂=(RELATIVE TIME(T_{f2}+ΔT_{f2}) at PASSAGE TIME1=0)[sec]

B₃=(RELATIVE TIME(T_{f3}+ΔT_{f3}) at PASSAGE TIME1=0)[sec]

B₄=(RELATIVE TIME(T_{f4}+ΔT_{f4}) at PASSAGE TIME1=0)[sec]

As described above, the relative time setting unit 210 can set the relative time using a linear function of a passage time 1. However, this embodiment is not limited thereto. For example, the relative time may be set using a high-dimensional function of a quadratic function or more or an exponential function. Alternatively, the relative time may be set using an arbitrarily set function. Similar to the case of the above Eqs. (1) to (4), a method of generalizing Aₖ*t(k=1 to 4) to an arbitrary function f′ₖ(t) is also considered.

### (Second Specific Example: Speed Excess→Speed Non-Excess)

Next, the case is considered in which the relative time is expressed by a linear function in regards to the passage time 2 after a state is changed from a speed excess state to a speed non-excess state. As the specific example that corresponds to FIG. 4, the case is assumed in which the four interpolation images CF_{F1}, CF_{F2}, CF_{F3}, and CF_{F4} are generated between the two original images OP₁ and OP₂, and the individual interpolation images are arranged at an equivalent interval and the interpolation process is changed to a smooth interpolation process. In addition, an example shown in FIG. 7 is assumed as a variation of the motion amount. However, it is assumed that a target time of the interpolation image CF_{Fk} (k=1 to 4) is T_{fk}=k/120 [sec].

Further, it is assumed that the original image OP₁ is an image of a time-series image signal of the time when the predetermined time t (frame unit) has passed from the time of the time-series image signal immediately after the state is changed from the speed excess state to the speed non-excess state (passage time 2=0), and the time thereof is a reference (0 sec) of the relative time. In this case, with respect to the passage time t (frame unit) from the original image OP₁, for example, the relative time (T_{fk}+ΔT_{fk}) of the interpolation image CF_{Fk} (k=1 to 4) is set as represented by the following Eqs. (9) to (12).

In the following Eq. (9) to (12), the reason why Bₖ (k=1 to 4) is defined as (a value of the relative time (T_{fk}+ΔT_{fk}) in the passage time 2=0) is because it may be assumed that the relative time is being set in accordance with the switching of the type of the image. In this case, instead of the time T_{fk} of the interpolation images CF_{Fk} (k=1 to 4) that are arranged at an equivalent interval, the relative time (T_{fk}+ΔT_{fk}) of each interpolation image in the passage time 2=0 becomes a setting reference. Even during another relative time setting process, continuity of the relative time information is maintained by the above setting.

If the following Eqs. (9) and (10) are compared with each other, the relative time of the interpolation image CF_{F1} that is closer to the original image OP₁ than the interpolation image CF_{F2} is set such that the inclination A₁ with respect to the passage time t is small. Each of the inclinations A₁ and A₂ indicates a variation amount of distance by which each of the interpolation images CF_{F1} and CF_{F2} becomes distant from the original image OP₁ in accordance with the progress of the passage time t. That is, the following Eqs. (9) and (10) show a setting method that sets a relative time, such that the interpolation image CF_{F2} further becomes distant from the original image OP₁ as time passes.

In the same way, if the following Eqs. (11) and (12) are compared with each other, the relative time of the interpolation image CF_{F4} that is closer to the original image OP₂ than the interpolation image CF_{F3} is set such that the inclination A₄ with respect to the passage time t is small. Each of the inclinations A₃ and A₄ indicates a variation amount of distance by which each of the interpolation images CF_{F3} and CF_{F4} becomes distant from the original image OP₂ in accordance with the progress of the passage time t. That is, the following Eqs. (11) and (12) show a setting method that sets a relative time, such that the interpolation image CF_{F3} further becomes distant from the original image OP₂ as time passes.

RELATIVE TIME(T_{f1}+ΔT_{f1})=A₁*t+B₁ (9)

RELATIVE TIME(T_{f2}+ΔT_{f2})=A₂*t+B₂ (10)

RELATIVE TIME(T_{f3}+ΔT_{f3})=A₃*t+B₃ (11)

RELATIVE TIME(T_{f4}+ΔT_{f4})=A₄*t+B₄ (12)

A₁=1/(120*60)[sec]

A₂=2/(120*60)[sec]

A₃=−2/(120*60)[sec]

A₄=−1/(120*60)[sec]

B₁=(RELATIVE TIME(T_{f1}+ΔT_{f1}) at PASSAGE TIME2=0)[sec]

B₂=(RELATIVE TIME(T_{f2}+ΔT_{f2}) at PASSAGE TIME2=0)[sec]

B₃=(RELATIVE TIME(T_{f3}+ΔT_{f3}) at PASSAGE TIME2=0)[sec]

B₄=(RELATIVE TIME(T_{f4}+ΔT_{f4}) at PASSAGE TIME2=0)[sec]

As described above, the relative time setting unit 210 can set the relative time using a linear function of a passage time 2. However, this embodiment is not limited thereto. For example, the relative time may be set using a high-dimensional function of a quadratic function or more or an exponential function. Alternatively, the relative time may be set using an arbitrarily set function. Similar to the case of the above Eqs. (1) to (4), a method of generalizing Aₖ*t(k=1 to 4) to an arbitrary function f″ₖ(t) is also considered.

The functional configuration of the display device 200 according to this embodiment has been described. As described above, the display device 200 according to this embodiment can set the relative time to generate the interpolation image to gradually approximate the time of the original image, with respect to the portion subsequent to the portion where the motion amount of the time-series image signal has exceeded the predetermined threshold value. In the same way, the display device 200 can set the relative time such that a portion where a state is changed from a state where the motion amount of the time-series image signal exceeds the predetermined threshold value to a state where the motion amount does not exceed the predetermined threshold value becomes gradually distant from the original image.

At this time, the display device 200 can set the relative time such that the relative time gradually approximates the target time in accordance with the passage time using a point of time when the speed excess/non-excess is switched as a base. For this reason, the rapid change is alleviated between an image where judders are generated and a smooth image after the interpolation process at a point of time when the speed excess/non-excess is switched, and it may become difficult for the viewer to recognize a switching portion of the interpolation process. As a result, it becomes difficult for the viewer to recognize a variation point between the images whose types are different from each other. As a result, it is possible to realize display that maximally implements smoothness of each image.

### [With Respect to Image Processing Method]

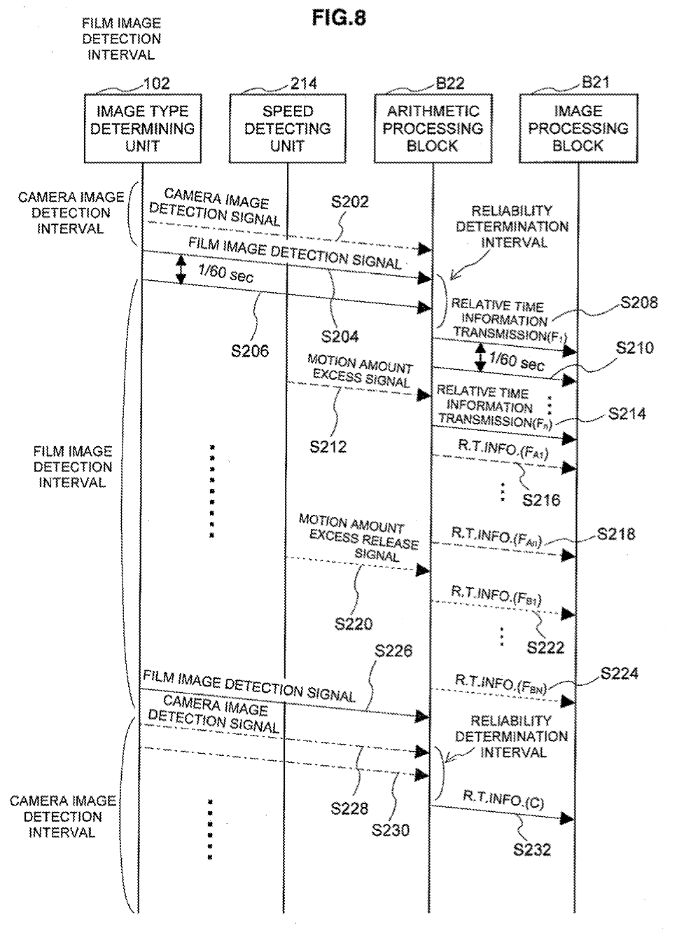

Next, a process flow of an image processing method according to this embodiment will be described with reference to FIG. 8. FIG. 8 is a diagram illustrating a process flow of an image processing method according to this embodiment. However, it is assumed that a time-series image signal of a camera image is input to the display device 200 at a first stage.

First, if a stream of the time-series image signal is input to the display device 200, the type of the image is determined by the image type determining unit 102. When the camera image is detected by the image type determining unit 102, as a determination result that indicates the camera image, a camera image detection signal is input to the arithmetic processing block B22 (S202). At this time, the type of the image of the time-series image signal does not vary as it is the camera image, the arithmetic processing block B22 may not input information about the interpolation method to the image processing block B21. As such, during a period (camera image detection interval) where the time-series image signal of the camera image is continuously input, the interpolation method by the image processing block B21 is not changed.

At any point of time, when the film image is detected by the image type determining unit 102 (film image detection interval), as a determination result that indicates the film image, the film image detection signal is input to the arithmetic processing block B22 (S204). If the film image detection signal is input, the reliability of the determination result is determined by the arithmetic processing block B22. During the reliability determination process (reliability determination interval), a plurality of film image detection signals are input to the arithmetic processing block B22 (S206). These film image detection signals are input in a frame period unit of a time-series image signal ( 1/60 [sec]).

If the reliability of the determination result of the image type is confirmed using the film image detection signals, the relative time is set by the arithmetic processing block B22, and the relative time information F₁ is transmitted to the image processing block B21 (S208).

The relative time information (Fₙ (n=1 to N) is generated whenever the film image detection signals are continuously input from the image type determining unit 102, and transmitted to the image processing block B21 (S210 and S214). At this time, the relative time that is indicated by the relative time information (Fₙ (n=1 to N) is set based on the above Eqs. (1) to (4).

However, at any point of time, if a motion amount excess signal indicating that the motion amount has exceeded the predetermined threshold value is input by the speed detecting unit 214 (S212), the arithmetic processing block B22 sets the relative time based on the above Eqs. (5) to (8) and transmits the relative time information F_{A1} to the image processing block B21 (S216). Then, the relative time information F_{An} (2≦n≦N) is continuously transmitted based on the above Eqs. (5) to (8) (S218).

In addition, at any point of time, if a motion amount excess release signal indicating that the motion amount has reached below the predetermined threshold value is input by the speed detecting unit 214 (S220), the arithmetic processing block B22 sets the relative time based on the above Eqs. (9) to (12) and transmits the relative time information F_{B1} to the image processing block B21 (S222). Then, the relative time information F_{Bn} (2≦n≦N) is continuously transmitted based on the above Eqs. (9) to (12) (S224). Further, during the above processes, regardless of the excess/non-excess of the motion amount, the film image detection signal is input from the image type determining unit 102 (S226).

Further, at any point of time, when the camera image is detected again by the image type determining unit 102, as a determination result that indicates the camera image, the camera image detection signal is input to the arithmetic processing block B22 (S228). If the camera image detection signal is input, the reliability of the determination result is determined by the arithmetic processing block B22.

During the reliability determination process (reliability determination interval), a plurality of camera image detection signals are input to the arithmetic processing block B22 (S230). If the reliability of the determination result of the image type is confirmed using the camera image detection signals, the relative time is set by the arithmetic processing block B22, and the relative time information C is transmitted to the image processing block B21 (S232).

However, the relative time information C, which is transmitted when a variation is made from the film image to the camera image, is information of the target time that is suitable for the camera image. The reason why the information of the target time is transmitted is to prevent unnatural motion from being generated between the images by continuously executing the interpolation process suitable for the film image, in a state where a stream of the time-series image signal is the type of the camera image, similar to the image processing method according to the first embodiment.

That is, the interpolation method may be switched into an interpolation method that is suitable for the camera image immediately after the variation is made from the film image to the camera image, which is the same as the image processing method according to the above-described first embodiment. If the relative time information C of the camera image is transmitted, the image processing block B21 executes an image process on a stream of the time-series image signal using an interpolation method suitable for the camera image and outputs the process result, during the camera image detection interval.

The process flow of the image processing method according to this embodiment has been described. As described above, according to the image processing method according to this embodiment, the relative time information is generated by the arithmetic processing block B22 in accordance with the type of the image that is detected by the image type determining unit 102. When the motion amount exceeds the predetermined threshold value or falls below the predetermined threshold value, the relative time information is set by the arithmetic processing block B22. In addition, the interpolation process is executed by the image processing block B21 based on the relative time that is set by the arithmetic processing block B22.

At that time, in the arithmetic processing block B22, the relative time is set such that the variation is gradually made from an image having judders generated in accordance with the switching of the type of the image to a smooth image. Further, the relative time is set such that the variation is gradually made from the smooth image to the image where the judders are generated in accordance with the variation in the motion amount. As a result, it is possible to alleviate a sense of discomfort that the viewer feels due to the rapid change in the interpolation process.

### First Modification

Next, a first modification of the second embodiment will he described. This modification relates to an interpolation processing method in the case where the rapid change in the motion or scene is detected in an input camera image. In the image processing method, when the excess (or excess release) of the motion amount is generated while the film image is input, the relative time is favorably adjusted. However, this method can be applied to the camera image.

For example, in accordance with the passage time t (frame unit) from a point of time when the motion amount of the predetermined threshold value or more is detected by the speed detecting unit 214 or a point of time when the speed excess is released, as represented by the following Eq. (13), the relative time T_{c1} of the interpolation image CF_{C1} is set (refer to FIG. 3). However, the relative time T_{c1} is controlled to satisfy the condition 0≦T_{c1}≦ 1/120 [sec] in accordance with target time resolution (for example, 1/120 [sec]).

T_{c1}=A₁*t+B₁ (13)

### Case 1: Detected the Speed Excess

A₁=−1/(120*60)[sec]

B₁=(T_{c1} at PASSAGE TIME 1=0)[sec]

### Case 2: Released the Speed Excess

A₁=1/(120*60)[sec]

B₁=(T_{c1} at PASSAGE TIME1=0)[sec]

As described above, the relative time T_{c1} can be set using a linear function of the passage time t. However, this embodiment is not limited thereto. For example, the relative time may be set using a high-dimensional function of a quadratic function or more or an exponential function. Alternatively, the relative time may be set using an arbitrarily set function. The first modification of this embodiment has been described. As described in the first modification, the interpolation processing method according to this embodiment can be applied to the camera image.

### Second Modification

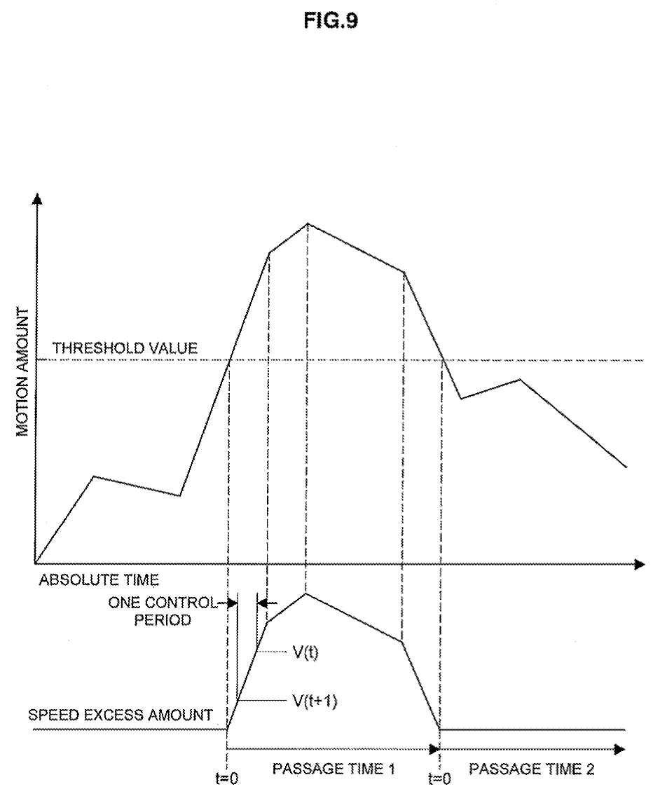

Next, a second modification of this embodiment will be described with reference to FIG. 9. This modification relates to the functions of the speed detecting unit 214 and the relative time setting unit 210 that are included in the display device 200. When the motion amount exceeds the predetermined threshold value, a setting value of the relative time is adjusted in accordance with the excess amount.

In the configuration of the display device 200 that has been described above, it is assumed that the interpolation process is temporarily stopped when the speed excess is generated. However, this modification relates to a technology in which, even when the speed excess is generated, the interpolation process is not stopped, and disturbance of an image is reduced by adjusting the relative time. This technology is used to achieve the following effect. The interpolation image is generated at the time that is close to the original image, thus an adverse effect due to erroneous motion information can be reduced. As a result, it is possible to suppress disturbance of an image.

### (With Respect to Function of a Speed Detecting Unit 214)

First, the function of the speed detecting unit 214 according to this modification will be described. In order to realize the above function, when the motion amount exceeds the predetermined threshold value, the speed detecting unit 214 inputs a variation of the speed excess amount V during one control period (for example, one frame unit) of the passage time to the relative time setting unit 210. Further, the speed detecting unit 214 may input the speed determination result to the relative time setting unit 210. However, the speed detecting unit 214 may input only the speed excess amount V.

### (With Respect to Function of a Relative Time Setting Unit 210)

The relative time setting unit 210 sets the relative time such that the interpolation image approximates the original image, in accordance with the speed excess amount V input from the speed detecting unit 214. For example, the relative time setting unit 210 sets the variation ΔT_{fk} (k=1 to 4) of the relative time as represented by the following Eqs. (14) to (17), in accordance with the speed excess amount V at the passage time t after the speed excess (which corresponds to the case of FIG. 4). However, V(t) indicates the speed excess amount at the passage time t.

ΔT_{f1}=A₁*(V(t)−V(t−1))+B₁ (14)

ΔT_{f2}=A₂*(V(t)−V(t−1))+B₂ (15)

ΔT_{f3}=A₃*(V(t)−V(t−1))+B₃ (16)

ΔT_{f4}=A₄*(V(t)−V(t−1))+B₄ (17)

A₁=−1/(120*30)[sec], B₁=−1/(120*60)[sec]

A₂=−2/(120*30)[sec], B₂=−1/(120*60)[sec]

A₃=2/(120*30)[sec], B₃=−1/(120*60)[sec]

A₄=1/(120*30)[sec], B₄=−1/(120*60)[sec]

However, when a difference (V(t)−V(t−1)) between the speed excess amounts exceeds 30, the relative time is set such that the interpolation image is matched with the original image within one control period.

As such, the variation ΔT_{fk} (k=1 to 4) of the relative time can be set by using a linear function with respect to a variation of the motion amount V at the passage time t. However, this embodiment is not limited thereto. For example, the relative time may be set using a high-dimensional function of a quadratic function or more or an exponential function.

Further, when the motion amount V becomes constant with respect to the passage of the passage time t, the same variation as represented by the above Eqs. (5) to (8) is made. Meanwhile, when the speed excess is released and the speed excess amount is not input from the speed detecting unit 214, the relative time setting unit 210 sets the relative time based on the above Eqs. (9) to (12), in accordance with the passage time t that uses a point of time when the speed excess is released as a base.

The second modification of this embodiment has been described. If the technology according to the second modification is applied, even when the motion amount between the time-series image signals exceeds the predetermined threshold value, disturbance of the image due to the reduction of the motion detection precision can be reduced. In this situation, an interpolation process is generally stopped to prevent unnecessary disturbance of an image from occurring due to the interpolation process.

However, according to this modification, since the interpolation process can be continuously executed while making disturbance of the image not recognized by the viewer, even though the rapid change in the motion or scene is generated, a relatively smooth image can be realized. Further, the rapid change of the interpolation process can be suppressed and a sense of discomfort that is given to the viewer can be further effectively reduced.

### [With Respect to Image Processing Method]

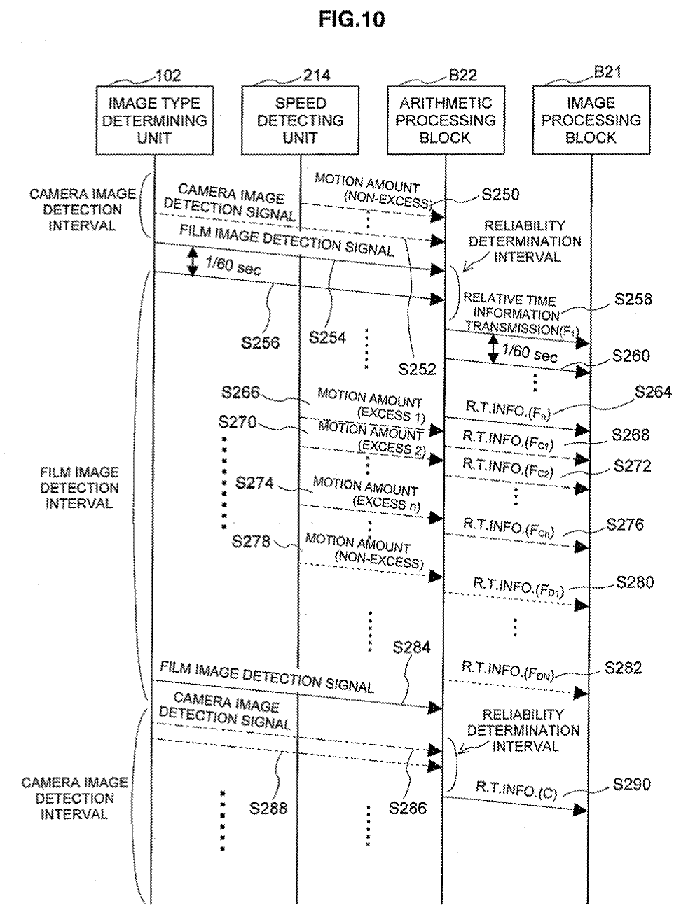

Here, a process flow of an image processing method according to the second modification of this embodiment will be described with reference to FIG. 10. FIG. 10 is a diagram illustrating a process flow of an image processing method according to this modification. However, it is assumed that a time-series image signal of a camera image is input to the display device 200 at a first stage. In addition, at the corresponding point of time, if is assumed that the motion amount does not exceed the threshold value (S250).

First, if a stream of the time-series image signal is input to the display device 200, the type of the image is determined by the image type determining unit 102. When the camera image is detected by the image type determining unit 102, as a determination result that indicates the camera image, a camera image detection signal is input to the arithmetic processing block B22 (S252).

At this time, since the type of the image of the time-series image signal does not vary as it is the camera image, the arithmetic processing block B22 may not input information about the interpolation method to the image processing block B21. As such, during a period (camera image detection interval) where the time-series image signal of the camera image is continuously input, the interpolation method by the image processing block B21 is not changed.

At any point of time, when the film image is detected by the image type determining unit 102 (film image detection interval), as a determination result that indicates the film image, the film image detection signal is input to the arithmetic processing block B22 (S254). If the film image detection signal is input, the reliability of the determination result is determined by the arithmetic processing block B22. During the reliability determination process (reliability determination interval), a plurality of film image detection signals are input to the arithmetic processing block B22 (S256).

If the reliability of the determination result of the image type is confirmed using the film image detection signals, the relative time is set by the arithmetic processing block B22, and the relative time information F₁ is transmitted to the image processing block B21 (S258).

The relative time information Fₙ (n=1 to N) is generated whenever the film image detection signals are continuously input from the image type determining unit 102, and transmitted to the image processing block B21 (S260 and S264). At this time, the relative time that is indicated by the relative time information Fₙ (n=1 to N) is set based on the above Eqs. (1) to (4).

However, at any point of time, if the speed excess amount (excess 1) of the motion amount is input by the speed detecting unit 214 (S266), the arithmetic processing block B22 sets the relative time based on the above Eqs. (14) to (17) and transmits the relative time information F_{C1} to the image processing block B21 (S268). Then, in accordance with the speed excess amounts (excess 2, . . . , and excess n) that are sequentially input from the speed detecting unit 214 (S270 and S274), the relative time information F_{C2,} . . . , and F_{Cn} are continuously transmitted (S272 and S276).

Further, at any point of time, if information indicating that the motion amount does not exceed the predetermined threshold value is input from the speed detecting unit 214 (S278), the arithmetic processing block B22 sets the relative time based on the above Eqs. (9) to (12) and transmits the relative time information F_{D1} to the image processing block B21 (S280).

Then, the relative time information F_{Dn} (2≦n≦N) is continuously transmitted based on the above Eqs. (9) to (12) (S282). Further, during the above processes, regardless of the excess/non-excess of the motion amount, the film image detection signal is input from the image type determining unit 102 (S284).

Further, at any point of time, when the camera image is detected again by the image type determining unit 102, as a determination result that indicates the camera image, the camera image detection signal is input to the arithmetic processing block B22 (S286). If the camera image detection signal is input, the reliability of the determination result is determined by the arithmetic processing block B22.

During the reliability determination process (reliability determination interval), a plurality of camera image detection signals are input to the arithmetic processing block B22 (S288). If the reliability of the determination result of the image type is confirmed using the camera image detection signals, the relative time is set by the arithmetic processing block B22, and the relative time information C is transmitted to the image processing block B21 (S290).

The process flow of the image processing method according to this modification has been described. According to the image processing method according to this modification, the relative time information is generated by the arithmetic processing block B22 in accordance with the type of the image that is detected by the image type determining unit 102. When the motion amount exceeds the predetermined threshold value or falls below the predetermined threshold value, the relative time information is set based on the speed excess amount.

In addition, the interpolation process is executed by the image processing block B21 based on the relative time that is set by the arithmetic processing block B22. As a result, even though the rapid change in the motion or scene is generated, it is possible to realize a relative smooth image. Further, the rapid change of the interpolation process can be suppressed and a sense of discomfort that is given to the viewer can be further effectively reduced.

### [Detailed Hardware Configuration Example]

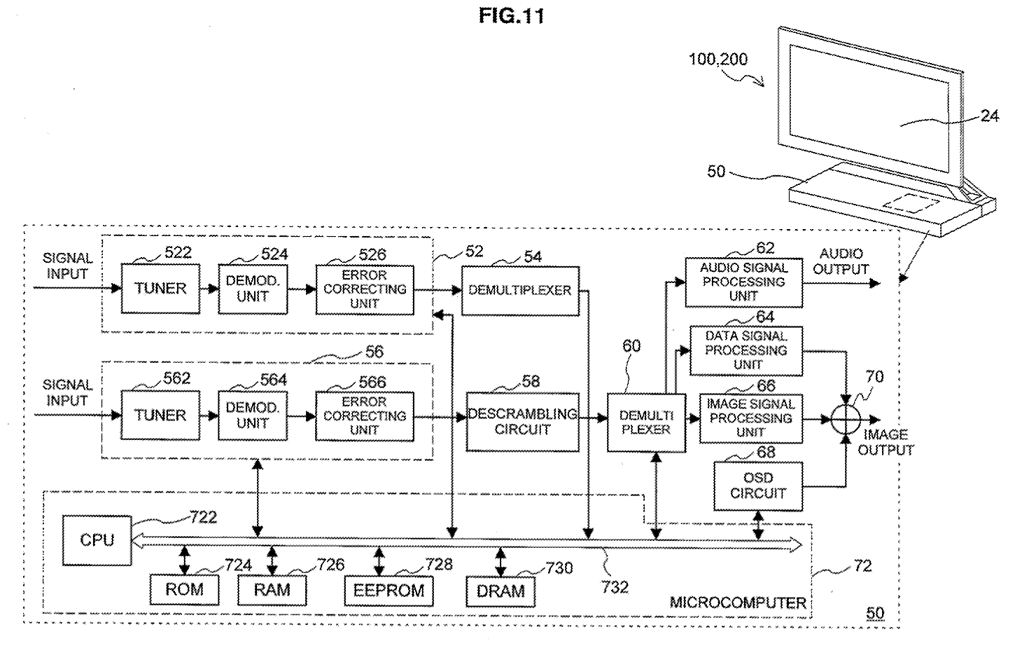

The image signal processing function that the device has can be realized by using a portion or all of the hardware configuration shown in FIG. 11. FIG. 11 is a diagram specifically illustrating an example of the hardware configuration to realize functions that an image signal processing unit of the device have.

As shown in FIG. 11, each of the display devices 100 and 200 includes a display panel 24 and a body stand 50. As the display panel 24, for example, a liquid crystal display panel or an organic EL panel is used. The organic EL panel is configured by using self-emission-type light emitting elements (organic EL elements), and does not need a device, such as a backlight. For this reason, the display device using the organic EL panel can be formed to be small-sized and light-weighted, as compared with the liquid crystal display panel that needs the device, such as the backlight. In actuality, the thickness of the organic EL panel can be suppressed to about 3 mm or less. Since a freedom degree of arrangement can be increased based on the above characteristic, if is anticipated that an organic EL panel is increasingly used as the display panel 24.

Meanwhile, an image processing unit of each of the display devices 100 and 200 is provided inside the body stand 50 where the display panel 24 is disposed or on the back side of the display panel 24. In the body stand 50, for example, various terminals, such as satellite broadcasting (BS and CS) and terrestrial digital broadcasting tuners, a local area network (LAN), a high-definition multimedia interface (HDMI), and a universal serial bus (USB), are incorporated. Further, the body stand 50 is provided with a receiving antenna (not shown), such as a rod antenna or a patch antenna, which receives terrestrial digital broadcasting. Furthermore, a speaker box for audio output and an operation button for a user operation are incorporated in the body stand 50.

In this case, the configuration of the image processing unit that is provided in the body stand 50 will be described. As shown in FIG. 11, the body stand 50 includes receiving circuits 52 and 56, demultiplexers 54 and 60, a descramble circuit 58, an audio signal processing unit 62, a data signal processing unit 64, an image signal processing unit 66, an OSD (On Screen Display) circuit 68, a synthetic circuit 70, and a microcomputer 72.

In this example, the body stand 50 is provided with the two systems of receiving circuits 52 and 56, and the two demultiplexers 54 and 60 that correspond to the receiving circuits. The receiving circuit 52 is a circuit that receives an additional information signal distributed through an arbitrary channel. Meanwhile, the receiving circuit 56 is a circuit that receives a program broadcasting signal distributed through the corresponding channel. When power is supplied to the image processing unit, the image processing unit receives an additional information signal through the receiving circuit 52. Further, the image processing unit receives a program broadcasting signal through the receiving circuit 56.

The microcomputer 72 controls various constituent elements of the image processing unit that is incorporated in the body stand 50. The microcomputer 72 includes a central processing unit (CPU) 722, a read only memory (ROM) 724, a random access memory (RAM) 726, an electrically erasable programmable ROM (EEPROM) 728, a dynamic RAM (DRAM) 730, and a bus 732. The CPU 722, the ROM 724, the RAM 726, the EEPROM 728, and the DRAM 730 are connected to each other through the bus 732.

In this case, based on the functions of the microcomputer 72, a series of processes that are executed by the image processing unit will be briefly described. The microcomputer 72 has a function of storing broadcasting information, such as a channel frequency or a program ID of a program broadcasting signal, which is received immediately before power supply is stopped, in the EEPROM 728. In addition, when power is supplied again, the microcomputer 72 can read out the broadcasting information of the program broadcasting signal, which is received immediately before power supply is stopped, from the EEPROM 728, and output a channel selection control signal to reselect a channel.

The channel selection control signal is input to the receiving circuit 56 that is connected through the bus 732, and then processed by the receiving circuit 56. Then, the channel selection control signal is processed by the descramble circuit 58 and then input to the demultiplexer 60. First, this process flow will be described. The tuner 562 that constitutes the receiving circuit 56 receives a program broadcasting signal at a channel frequency that is indicated by the channel selection control signal that is input from the microcomputer 72. In addition, the program broadcasting signal that is received by the tuner 562 is input to a demodulating unit 564. The demodulating unit 564 demodulates the program broadcasting signal that is modulated by a predetermined modulation scheme and generates a stream signal.

In addition, the stream signal that is generated by the demodulating unit 564 is input to an error correcting unit 566. The error correcting unit 566 executes an error correction process on the input stream signal and inputs the stream signal to the descramble circuit 58. At this time, the error correcting unit 566 executes an error correction process on a stream signal that is encoded by an encoding scheme using a Reed-Solomon code. Based on information that is acquired from the microcomputer 72, the descramble circuit 58 releases a scramble that is executed on the stream signal after the error correction and reproduces the program broadcasting signal. The program broadcasting signal from which the scramble is released by the descramble circuit 58 is input to the demultiplexer 60.

Next, a process flow until an image or audio signal is output from the program broadcasting signal input to the demultiplexer 60 will be described. The demultiplexer 60 extracts broadcasting program data from the program broadcasting signal based on the selection control signal that is input from the microcomputer 72 through the bus 732. In addition, the demultiplexer 60 inputs the broadcasting program data to the audio signal processing unit 62, the data signal processing unit 64, or the image signal processing unit 66 in accordance with the type of the extracted broadcasting program data. In the audio signal processing unit 62, the audio signal is generated from the input broadcasting program data. In the data signal processing unit 64, an image signal to display a character or an image is generated from the input broadcasting program data. In the image signal processing unit 66, an image signal to display an image is generated from the input broadcasting program data.

The audio signal that is generated by the audio signal processing unit 62 is output to an audio output terminal (not shown). The image signal that is generated by the data signal processing unit 64 is input to the synthetic circuit 70. Similarly, the image signal that is generated by the image signal processing unit 66 is input to the synthetic circuit 70. Further, the synthetic circuit 70 also receives an image signal that is generated by the OSD circuit 68. The OSD circuit 68 generates an image signal that is used to display an electronic program guidance table or various guidance messages. If these image signals are input, the synthetic circuit 70 synthesizes the image signals that are input from the data signal processing unit 64, the image signal processing unit 66, and the OSD circuit 68, and outputs the synthesized image signal to the image output terminal (not shown).

Next, a process flow until the additional information signal is received by the receiving circuit 52 and input to the demultiplexer 54 will be briefly described. The microcomputer 72 specifies a channel frequency based on the additional information signal that is multiplexed to the channel-selected channel signal, and inputs a channel selection control signal indicating the channel frequency to the receiving circuit 52. The tuner 522 that constitutes the receiving circuit 52 receives the additional information signal based on the channel selection control signal that is input from the microcomputer 72. The additional information signal that is received by the tuner 522 is input to the demodulating unit 524. The demodulating unit 524 demodulates the additional information signal that is input from the tuner 522 and inputs the demodulated additional information signal to the error correcting unit 526. The error correcting unit 526 executes an error correction process on the additional information signal that is input from the demodulating unit 524. In addition, the additional information signal whose error has corrected by the error correcting unit 526 is input to the demultiplexer 54.

The demultiplexer 54 extracts additional information, such as electronic program guidance, from the additional information signal after the error correction, under the control by the microcomputer 72. The extracted additional information is input to the microcomputer 72. The microcomputer 72 temporarily stores the additional information extracted by the demultiplexer 54 in the DRAM 730. The microcomputer 72 controls the OSD circuit 68 through the bus 732, such that the OSD signal, such as the electronic program guidance, is output based on the additional information.

The hardware configuration to realize the functional configuration of the image processing unit has been described using the specific example. The configuration has been described as an example where the technology according to this embodiment can be applied, but this embodiment is not limited to the above example.

It should be understood by those skilled in the art that various modifications, combinations, sub-combinations and alterations may occur depending on design and other factors insofar as they are within the scope of the appended claims or the equivalents thereof.

For example, in the description according to the embodiments, as the calculation expression of the relative time, the case where switching is made between the camera image and the film image or the motion amount exceeds the predetermined threshold value has been exemplified. However, a coefficient or an expression may be changed based on the following conditional difference. For example, in the case where switching between image quality modes (brightness, contrast, and sharpness) or a difference between film schemes (2-2 film/3-2 film) is detected, the calculation expression of the relative time may be changed in accordance with the corresponding situation.

Further, in the case where the motion amount exceeds the threshold value and the interpolation image approximates the original image and the case where the motion amount falls below the threshold value and the interpolation images are arranged at an equivalent interval, different calculation expressions may be used. Further, as the calculation expression with respect to the relative time of the camera image and the calculation expression with respect to the relative time of the film image, different calculation expressions may be used. In addition, a different calculation expression may be used with respect to a difference between speed excess detection factors (partial speed excess, scene change, pan, and zoom-in/out) by the speed detecting unit 214.

In addition to the above example, a different calculation expression (function form) may be used in each of a plurality of interpolation images CF_{FK} (k=1 to 4) that are generated between the two original images OP₁ and OP₂. Of course, it is needless to say that the number of interpolation images generated in accordance with the target time resolution or the target time is different. As such, various modifications can be made.

What is claimed is:

1. An image processing apparatus that generates interpolation image signals based on a motion vector between continuously input time-series image signals and increases time resolution, the image processing apparatus comprising:
a feature variation detecting unit that detects a predetermined feature variation between the time-series image signals;
a generation time setting unit that sets a generation time of the interpolation image signals; and
an interpolation image signal generating unit that generates the interpolation image signals at the generation time set by the generation time setting unit,
wherein, when the generation time setting unit sets the generation time after the feature variation of the time-series image signals has been detected by the feature variation detecting unit, the generation time setting unit sets the generation time to approximate an approximation time of any one of the time-series image signals whose times are arranged before and after the generation time.

2. The image processing apparatus according to claim 1,
wherein the generation time setting unit sets the generation time, such that an approximation degree of the generation time decreases when a time difference between the time-series image signals whose feature variation has been detected by the feature variation detecting unit and the time-series image signals whose times are arranged before the generation time increases.

3. The image processing apparatus according to claim 2,
wherein the feature variation detecting unit detects a time resolution difference between the time-series image signals as the predetermined feature variation.

4. The image processing apparatus according to claim 2,
wherein the feature variation detecting unit detects whether a motion amount between the time-series image signals exceeds a predetermined value as the predetermined feature variation.

5. The image processing apparatus according to claim 4,
wherein the generation time setting unit sets the generation time such that an approximation degree of the generation time increases when the motion amount between the time-series image signals increases.

6. The image processing apparatus according to claim 2,
wherein the feature variation detecting unit detects image scene switching between the time-series image signals as the predetermined feature variation.

7. An image processing method that generates interpolation image signals based on a motion vector between continuously input time-series image signals and increases time resolution, the image processing method comprising the steps of:
detecting a predetermined feature variation between the time-series image signals;
setting a generation time of the interpolation image signals; and
generating the interpolation image signals at the generation time set in the generation time setting step,
wherein, in the generation time setting step, when the generation time is set after the feature variation of the time-series image signals has been detected in the feature variation detecting step, the generation time is set to approximate an approximation time of any one of the time-series image signals whose times are arranged before and after the generation time.
